(19) United States
(12) Patent Application Publication
(10) Pub. No.: US 2023/0049146 A1
(43) Pub. Date: Feb. 16, 2023

(54) LITHIUM RECOVERY FROM LIQUID STREAMS

(71) Applicant: Gradiant Corporation, Woburn, MA (US)

(72) Inventors: Siva Kumar Kota, Sengkang (SG); Hiep Thanh Huynh Le, Broadview (AU); Kushal Seth, Cypress, TX (US)

(73) Assignee: Gradiant Corporation, Woburn, MA (US)

(21) Appl. No.: 17/978,521

(22) Filed: Nov. 1, 2022

Related U.S. Application Data
(63) Continuation of application No. PCT/US2021/047614, filed on Aug. 25, 2021.
(60) Provisional application No. 63/164,649, filed on Mar. 23, 2021.

(51) Int. Cl. C25B 15/08; B01D 1/14; B01D 5/00; B01D 61/02; B01D 61/04; C25B 1/34; C01D 15/04; C01D 15/02

(52) U.S. Cl. CPC C25B 15/085; B01D 1/14; B01D 5/006; B01D 5/003; B01D 61/026; B01D 61/04; C25B 1/34; C25B 15/083; C01D 15/04; C01D 15/02; B01D 2311/04; B01D 2311/08; B01D 2317/022; B01D 2317/08

(57) ABSTRACT

Methods and systems directed to recovery of lithium (e.g., lithium salts) from liquid streams are provided. In some embodiments, methods relate to obtaining lithium (e.g., as a solid lithium salt) by removing at least a portion of liquid from a feed stream to form a concentrated stream with respect to solubilized lithium cations. Liquid removal may include transporting at least a portion of the feed stream to an osmotic unit and/or a humidifier. Some methods include removing impurities (e.g., non-lithium cations) from the concentrated stream (e.g., via precipitation and/or crystallization). In some embodiments, solutions containing solubilized lithium cations and anions are electrochemically-treated such that first solubilized anions are replaced with second, different anions. In some embodiments, solid lithium salt containing at least a portion of the lithium cations and the second anions is obtained (e.g., via precipitation and/or crystallization following concentration of the electrochemically-treated solution in a humidifier).

### RELATED APPLICATIONS

This application is a continuation of International Patent Application No. PCT/US2021/047614, filed Aug. 25, 2021 and entitled “Lithium Recovery from Liquid Streams,” which claims priority under 35 U.S.C. § 119(e) to U.S. Provisional Patent Application No. 63/164,649, filed Mar. 23, 2021, and entitled “Lithium Recovery from Liquid Streams,” each of which is incorporated herein by reference in its entirety for all purposes.

### TECHNICAL FIELD

Methods and systems directed to recovery of lithium (e.g., lithium salts) from liquids are provided.

### BACKGROUND

Lithium is a commercially valuable resource that can be recovered from a variety of sources, such as brines (e.g., seawater, salt lake brines, underground water), ores, and waste products such as lithium ion batteries. Lithium is often found as a solubilized ion in liquid mixtures along with other non-lithium species. Improved methods and systems for obtaining lithium (including lithium salts of relatively high purity in some instances) are desirable.

### SUMMARY

Methods and systems directed to recovery of lithium (e.g., lithium salts) from liquid streams are provided. The subject matter of the present invention involves, in some cases, interrelated products, alternative solutions to a particular problem, and/or a plurality of different uses of one or more systems and/or articles.

In one aspect, methods are provided. In some embodiments, a method comprises removing at least a portion of liquid from a feed stream comprising the liquid, a solubilized lithium cation, and a solubilized non-lithium cation, to form a concentrated stream having a higher concentration of the solubilized lithium cation compared to the feed stream, wherein the removing comprises: (a) transporting an osmotic unit inlet stream comprising at least a portion of the feed stream to a retentate side of an osmotic unit such that: an osmotic unit retentate outlet stream exits the retentate side of the osmotic unit, the osmotic unit retentate outlet stream having a concentration of solubilized lithium cations that is greater than a concentration of solubilized lithium cations in the osmotic unit retentate inlet stream, such that at least a portion of the osmotic unit retentate outlet stream is part of the concentrated stream, and at least a portion of liquid from the osmotic unit retentate inlet stream is transported from the retentate side of the osmotic unit, through an osmotic membrane of the osmotic unit, to a permeate side of the osmotic unit; and/or (b) transporting a humidifier liquid inlet stream comprising at least a portion of the feed stream to a humidifier and allowing at least a portion of liquid of the humidifier liquid inlet stream to evaporate within the humidifier to produce a humidified gas stream and a humidifier liquid outlet stream having a higher concentration of the solubilized lithium cation compared to the humidifier liquid inlet stream, such that at least a portion of the humidifier liquid outlet stream is part of the concentrated stream; and removing at least some of the solubilized non-lithium cations from the concentrated stream to form an impurity-depleted concentrated steam having an atomic ratio of solubilized lithium cations to solubilized non-lithium cations that is larger than an atomic ratio of solubilized lithium cations to solubilized non-lithium cations in the concentrated stream.

In some embodiments, a method for obtaining a solid lithium salt from a liquid is provided. In some embodiments, a method comprises applying a voltage to an electrochemical cell comprising an initial solution comprising a liquid, solubilized lithium cations, and solubilized first anions, such that at least a portion of the first anions are replaced by second, different anions, thereby forming an electrochemically-treated solution comprising the liquid, solubilized lithium cations, and solubilized second anions at a concentration greater than a concentration of the solubilized second anions in the initial solution; allowing at least a portion of liquid from the electrochemically-treated solution to evaporate within a humidifier to produce a humidified gas stream and a humidifier liquid outlet stream having a higher concentration of the solubilized lithium cations and the solubilized second anions compared to the electrochemically-treated solution; and obtaining solid lithium salt comprising at least a portion of the lithium cations and at least a portion of the second anions from the humidifier liquid outlet stream.

In some embodiments, a method comprises removing at least a portion of liquid from a feed stream comprising a liquid and a solubilized lithium cation to form a concentrated stream having a higher concentration of the solubilized lithium cation compared to the feed stream, wherein the removing comprises: transporting a first osmotic unit inlet stream comprising at least a portion of the feed stream to a retentate side of a first osmotic unit such that: a first osmotic unit retentate outlet stream exits the retentate side of the first osmotic unit, the first osmotic unit retentate outlet stream having a concentration of solubilized lithium cations that is greater than a concentration of solubilized lithium cations in the first osmotic unit retentate inlet stream, and at least a portion of liquid from the first osmotic unit retentate inlet stream is transported from the retentate side of the first osmotic unit, through an osmotic membrane of the osmotic unit, to a permeate side of the first osmotic unit; and transporting a second osmotic unit retentate inlet stream comprising at least a portion of the first osmotic unit retentate outlet stream to a retentate side of a second osmotic unit such that: a second osmotic unit retentate outlet stream exits the retentate side of the second osmotic unit, the second osmotic unit retentate outlet stream having a higher concentration of solubilized lithium cations than a concentration of solubilized lithium cations of the second osmotic unit retentate inlet stream, such that at least a portion of the second osmotic unit retentate outlet stream is part of the concentrated stream, and at least a portion of liquid from the second osmotic unit retentate inlet stream is transported from the retentate side of the second osmotic unit, through an osmotic membrane of the second osmotic unit, to a permeate side of the second osmotic unit where the portion of the liquid is combined with a second osmotic unit permeate inlet stream to form a second osmotic unit permeate outlet stream that is transported out of the permeate side of the second osmotic unit; wherein: a concentration of solubilized lithium cations in the feed stream is greater than or equal to 10 mg/L, and a ratio of a concentration of solubilized lithium cations in the concentrated stream to the concentration of solubilized lithium cations in the feed stream is greater than or equal to 4.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a schematic diagram of a system for obtaining a lithium salt comprising an osmotic unit that receives a feed stream and produces a retentate outlet stream that can form some or all of a concentrated stream, in accordance with certain embodiments;

FIG. 1B is a schematic diagram of a system for obtaining a lithium salt comprising an osmotic unit that receives a feed stream and produces a retentate outlet stream that can form some or all of a concentrated stream, and where a recycle stream is fed back to a retentate inlet stream of the osmotic unit, in accordance with certain embodiments;

FIG. 2A is a schematic diagram of a system for obtaining a lithium salt comprising a humidifier that receives a feed stream and produces a humidifier outlet stream that can form some or all of a concentrated stream, in accordance with certain embodiments;

FIG. 2B is a schematic diagram of a system for obtaining a lithium salt comprising a humidifier that receives a feed stream and produces a humidifier outlet stream that can form some or all of a concentrated stream, and where a humidified gas stream from the humidifier may be fed to a dehumidifier for condensation, in accordance with certain embodiments;

FIG. 3A is a schematic diagram of a system for obtaining a lithium salt comprising an osmotic unit and a humidifier, in accordance with certain embodiments;

FIG. 3B is a schematic diagram of a system for obtaining a lithium salt comprising a first osmotic unit, a second osmotic unit, and a humidifier, in accordance with certain embodiments

FIG. 3C is a schematic diagram of a system comprising a first osmotic unit and a second osmotic unit;

FIG. 4A is a schematic diagram of a system for obtaining a lithium salt comprising a non-lithium-containing salt production unit that receives a concentrated stream and produces an impurity-depleted concentrated stream, in accordance with certain embodiments;

FIG. 4B is a schematic diagram of a system for obtaining a lithium salt comprising a non-lithium-containing salt production unit comprising a precipitation unit and a cooling unit, in accordance with certain embodiments;

FIGS. 5A-5B are schematic diagrams showing an electrochemical cell with an initial solution (FIG. 5A) and during application of a voltage (FIG. 5B), in accordance with certain embodiments;

FIG. 5C is a schematic diagram of a system for obtaining a lithium salt comprising an electrochemical cell and a humidifier, in accordance with certain embodiments;

FIG. 6 is a schematic diagram of a system for obtaining a lithium salt comprising an osmotic unit, a first humidifier, a non-lithium-containing salt production unit, an electrochemical cell, a second humidifier, and a solid lithium salt formation unit, in accordance with certain embodiments;

FIG. 7A is a schematic illustration of a single-membrane osmotic unit, in accordance with certain embodiments;

FIG. 7B is a schematic illustration of an osmotic unit comprising multiple osmotic membranes fluidically connected in parallel, in accordance with certain embodiments;

FIG. 7C is a schematic illustration of an osmotic unit comprising multiple osmotic membranes fluidically connected in series, in accordance with certain embodiments;

FIG. 8 is a schematic illustration of a system for obtaining a lithium salt from a brine, in accordance with certain embodiments;

FIG. 9 is a schematic illustration of a system for obtaining a lithium salt from a solution comprising anions such as sulfate and carbonate, in accordance with certain embodiments;

FIG. 10 is a schematic illustration of a system for obtaining a lithium salt from a solution derived from lithium ion batteries, in accordance with certain embodiments; and

FIG. 11 is a schematic illustration of a system for concentrating a lithium-containing stream, in accordance with certain embodiments.

### DETAILED DESCRIPTION

Methods and systems directed to recovery of lithium (e.g., as lithium salts) from liquid streams are provided. In some embodiments, methods relate to obtaining lithium (e.g., as a solid lithium salt) by removing at least a portion of liquid from a feed stream to form a concentrated stream with respect to solubilized lithium cations. Liquid removal may include transporting at least a portion of the feed stream to an osmotic unit and/or a humidifier. Some methods include removing impurities (e.g., non-lithium cations) from the concentrated stream (e.g., via precipitation and/or crystallization). In some embodiments, solutions containing solubilized lithium cations and anions are electrochemically-treated such that first solubilized anions are replaced with second, different anions. In some embodiments, solid lithium salt containing at least a portion of the lithium cations and the second anions are obtained (e.g., via precipitation and/or crystallization following concentration of an electrochemically-treated solution in a humidifier).

Recovery of lithium (e.g., lithium salts) from liquids (e.g., brines, ores, battery waste) is a commercially and industrially important process. However, such recovery can be difficult because typical lithium sources also include one or more impurities. For example, typical brines having appreciable lithium ion content have orders of magnitude greater concentrations of sodium, potassium, calcium and, in some instances, other ions such as magnesium, iron, aluminum, manganese, strontium, and/or barium. Certain strategies for separating lithium ions from potential impurities rely on chemical treatment of liquid sources. The chemical treatment may be used to selectively precipitate non-lithium cations. For example, liquid sources comprising lithium, potassium, and sodium may be chemically treated to form sulfates (e.g., by salt metathesis). Lower solubilities of potassium sulfates and sodium sulfates compared to lithium sulfates can be leveraged for separation (e.g., via selective precipitation and/or concentration). These typical lithium separation techniques tend to require energy-intensive and/or slow concentration (e.g., via solar concentration) and chemical treatment/separation processes that are expensive and capital-intensive.

It has been realized in the context of this disclosure that improved liquid concentration techniques (e.g., in terms of energy expenditure and/or speed) are possible by using different liquid concentration and/or ion exchange techniques than are typically employed for lithium recovery. For example, osmotic separation and humidification/dehumidification techniques, either alone or in combination, can provide relatively high concentrations of lithium ions from a variety of sources at greater speed and/or lower energy expenditure than typical techniques. Furthermore, osmotic separation and humidification/dehumidification processes can promote greater liquid recovery, lower liquid consumption, and less waste production requiring discharge than typical lithium recovery techniques. It has also been realized that electrochemical treatment of solutions rich in lithium can, in some instances, reliably and efficiently exchange anions to produce commercially valuable lithium salts, such as lithium hydroxides. Electrochemical treatment techniques (e.g., electrolysis) can, in some embodiments, be readily integrable with osmotic separation and/or humidification/dehumidification techniques to yield lithium in a desirable form (e.g., solid lithium salts such as crystallized lithium hydroxide).

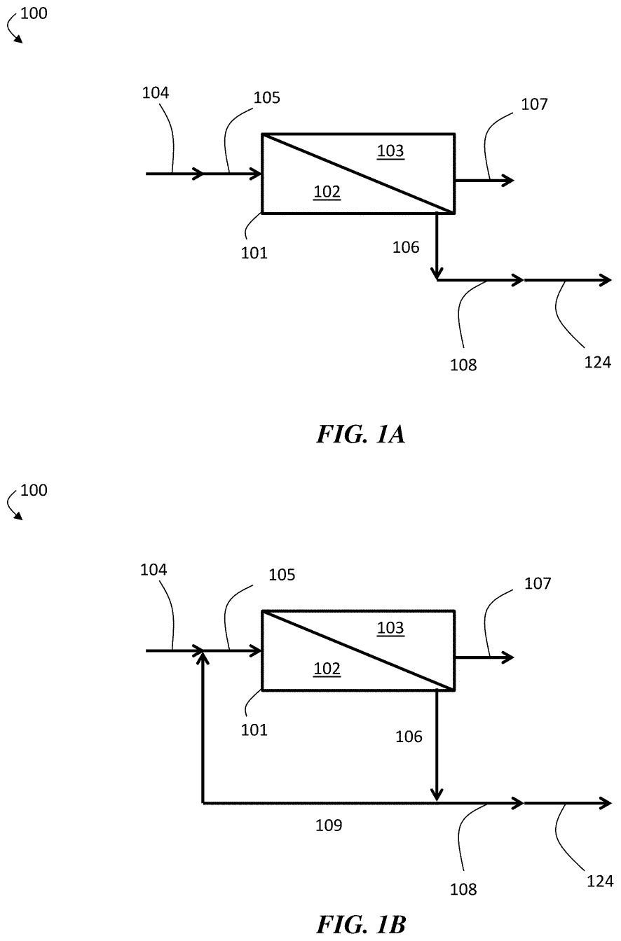

One aspect of this disclosure is directed to the recovery of lithium from liquids (e.g., from liquid streams). Lithium recovery may comprise obtaining lithium (e.g., as lithium salt) from such liquids. Lithium recovery may be performed using a lithium recovery system. FIGS. 1A-3B and FIG. 6 are schematic diagrams of examples of lithium recovery system 100, according to certain embodiments. In some embodiments, some or all of the lithium is recovered in the form of a lithium salt in a solid form. In some embodiments, some or all of the lithium is recovered in the form of a solution comprising solubilized lithium cations. In some embodiments, some or all of the lithium is recovered in the form of a solution or suspension comprising a relatively high concentration of lithium cations compared to non-lithium cations.

In some embodiments, a lithium salt is obtained at least in part by removing at least a portion of liquid from a feed stream comprising the liquid, a solubilized lithium cation, and a solubilized non-lithium cation, to form a concentrated stream. As described in more detail below, the concentrated stream may be subjected to one or more further downstream processes as part of the method of obtaining lithium (e.g., as a lithium salt), such as removal of impurities (e.g., non-lithium cations), anion exchange, and/or solid lithium salt formation (e.g., via precipitation or crystallization). In some embodiments, at least some (e.g., at least 75 wt %, at least 80%, at least, at least 90 wt %, at least 95 wt %, at least 98 wt %, at least 99 wt %, at least 99.9 wt %, or even 100 wt %) of the liquid of the feed stream is removed during formation of the concentrated stream. In some embodiments, at least some of the liquid is removed from the feed stream via an osmotic unit and/or a humidifier, as described in more detail below.

The methods and systems described herein can be used to process a variety of feed streams. Generally, the feed stream comprises at least one liquid and at least one solubilized species (also referred to herein as a solute). According to certain embodiments, the feed stream comprises solubilized ions. The solubilized ion(s) may originate, for example, from a salt that has been dissolved in the liquid of the feed stream. A solubilized ion is generally an ion that has been solubilized to such an extent that the ion is no longer ionically bonded to a counter-ion. As mentioned above, the feed stream may comprise a solubilized lithium cation and at least one solubilized non-lithium cation. The solubilized non-lithium cation may be a non-lithium monovalent cation (i.e., a cation having a redox state of +1 when solubilized). In some embodiments, the non-lithium cation is a divalent cation (i.e., a cation having a redox state of +2 when solubilized). In some embodiments, the non-lithium cation is chosen from one or more of sodium cation (Na⁺), potassium cation (K⁺), magnesium cation (Mg²⁺), and calcium cation (Ca²⁺). In addition to the solubilized lithium cation and non-lithium cation(s), the feed stream may comprise any of a variety of other solubilized species. For example, the feed stream may comprise solubilized anions. The solubilized anions may include monovalent anions (i.e., anions having redox state of −1 when solubilized) and/or divalent anions (i.e., anions having redox state of −2 when solubilized). In some embodiments, the feed stream comprises an anion chosen from one or more of chloride, sulfate, carbonate, bicarbonate, nitrate, borate, phosphate, bromide, citrate, oxide, and hydride. Cations and/or anions having other valencies may also be present in feed streams (e.g., an aqueous feed stream), in some embodiments.

In some embodiments, the total concentration of solubilized ions in the feed stream can be relatively high. One advantage associated with certain embodiments is that initial feed streams (e.g., aqueous feed streams) with relatively high solubilized ion concentrations can undergo liquid removal (e.g., for lithium concentrating) without the use of energy intensive desalination methods. In certain embodiments, the total concentration of solubilized ions in the feed stream transported into a lithium recovery system is at least 1,000 mg/L, at least 5,000 mg/L, at least 10,000 mg/L, at least 12,000 mg/L, at least 14,000 mg/L, and/or up to 50,000 mg/L, up to 60,000 mg/L, up to 100,000 mg/L, up to 500,000 mg/L, or greater.

According to certain embodiments, the feed stream that is transported to the lithium recovery system comprises a suspended and/or emulsified immiscible phase. Generally, a suspended and/or emulsified immiscible phase is a material that is not soluble in water to a level of more than 10% by weight at the temperature and other conditions at which the stream is operated. In some embodiments, the suspended and/or emulsified immiscible phase comprises oil and/or grease. The term “oil” generally refers to a fluid that is more hydrophobic than water and is not miscible or soluble in water, as is known in the art. Thus, the oil may be a hydrocarbon in some embodiments, but in other embodiments, the oil may comprise other hydrophobic fluids. In some embodiments, at least 0.1 wt %, at least 1 wt %, at least 2 wt %, at least 5 wt %, or at least 10 wt % (and/or, in some embodiments, up to 20 wt %, up to 30 wt %, up to 40 wt %, up to 50 wt %, or more) of a feed stream (e.g., an aqueous feed stream) is made up of a suspended and/or emulsified immiscible phase.

In some embodiments, the feed stream is treated to remove at least some impurities prior to liquid removal steps described below. For example, impurities such as heavy metals (e.g., iron, aluminum, manganese, barium, strontium) or silica can be removed from the feed stream prior to liquid removal (e.g., prior to the osmotic separation and/or humidifier concentration processes described below). In some instances, at least some of these impurities are removed via chemical precipitation. Such a chemical precipitation process may include addition of reagents including, but not limited to, aluminates (e.g., sodium aluminate), inorganic compounds (e.g., FeCl₃), activated alumina, hypochlorites (e.g., sodium hypochlorite), bases (e.g., caustic soda (NaOH)), acids, and/or polymers. The feed stream may also be fed through one or more ion exchange media, such as an ion exchange column, prior to undergoing the liquid removal steps described below.

While one or more components of the lithium recovery system can be used to separate a suspended and/or emulsified immiscible phase from an incoming feed stream, such separation is optional. For example, in some embodiments, the feed stream transported to the lithium recovery system is substantially free of a suspended and/or emulsified immiscible phase. In certain embodiments, one or more separation units upstream of the lithium recovery system can be used to at least partially remove a suspended and/or emulsified immiscible phase from a feed stream before the feed stream is transported to a component of the lithium recovery system (e.g., an osmotic unit and/or humidifier). Non-limiting examples of such systems are described, for example, in International Patent Publication No. WO 2015/021062, published on Feb. 12, 2015, which is incorporated herein by reference in its entirety for all purposes.

In some embodiments, the feed stream can be derived from seawater, ground water, brackish water, and/or the effluent of a chemical process. In some cases, the systems and methods described herein can be used to recover lithium from and in some instances at least partially desalinate aqueous feed streams derived from such process streams. As one example, the feed stream may be derived from water used in applications that expose water to salts and minerals, such as some mining methods. As another example, the feed stream may be a product of an ion extraction process from waste sources, such as spent lithium ion batteries. In some embodiments, the feed stream is or is derived from a lithium-containing brine. Such brines may be sourced from, for example, the Dead Sea in Israel, the Great Salt Lake in the USA, Searles Lake in the USA, Clayton Valley in the USA, Salton Sea in the USA, Bonneville in the USA, Sua Pan in India, Zabuye in China, Taijinaier in China, Salar de Uyuni in Bolivia, Salton Sea in the USA, Salar del Hombre Muerto in Argentina, and/or Salar de Atacama in Chile.

A variety of types of liquids could also be used in the feed stream. In some embodiments, the liquid of the feed stream comprises water. For example, in some embodiments, at least 10 wt %, at least 25 wt %, at least 50 wt %, at least 75 wt %, at least 90 wt %, at least 95 wt %, at least 98 wt %, at least 99 wt %, at least 99.9 wt %, or more (e.g., all) of the liquid is water. Other examples of potential liquids for the feed steam include, but are not limited to alcohols and/or hydrocarbons. The liquid of the feed stream may be a mixture of different liquid-phase species. For example, the liquid may be a mixture of water and a water-miscible organic liquid, such as an alcohol.

The feed stream may have any of a variety of concentrations of solubilized lithium cations, depending on the feed stream source and/or desired application. The versatility of the techniques described in this disclosure may allow for lithium recovery from relatively lithium-poor liquid sources due to an ability in some embodiments to effectively concentrate liquids by orders of magnitude. Alternatively or in addition, the versatility of the techniques described in this disclosure may allow for lithium recovery from relatively lithium-rich sources due to an ability in some embodiments to remove liquid from highly concentrated streams with comparatively low energy input and/or stress on system components compared to typical concentration techniques. In some embodiments, the feed stream has a concentration of solubilized lithium cations of greater than or equal to 10 mg/L, greater than or equal to 50 mg/L, greater than or equal to 100 mg/mL, greater than or equal to 200 mg/L, greater than or equal to 500 mg/L, or higher. In some embodiments, the feed stream has a concentration of solubilized lithium cations of less than or equal to 2,000 mg/L, less than or equal to 1,600 mg/mL, less than or equal to 1,200 mg/L, less than or equal to 1,000 mg/L, less than or equal to 800 mg/L, less than or equal to 680 mg/L, less than or equal to 600 mg/L, or less. Combinations of these ranges (e.g., greater than or equal to 10 mg/L and less than or equal to 2,000 mg/L or greater than or equal to 10 mg/L and less than or equal to 680 mg/L) are possible. The concentration of one or more solubilized ions (e.g., lithium cations, non-lithium cations, etc.) may be measured according to any method known in the art. For example, suitable methods for measuring the concentration of one or more solubilized ions include inductively coupled plasma (ICP) spectroscopy (e.g., inductively coupled plasma optical emission spectroscopy). As one non-limiting example, an Optima 8300 ICP-OES spectrometer may be used.

The concentrated stream formed by the removal of the liquid from the feed stream may have a higher concentration of solubilized lithium cations compared to the feed stream. It has been realized in the context of this disclosure that concentrating lithium cations (e.g., by removing liquid) can promote, in some instances, effective removal of impurities such as non-lithium cations. For example, as described below, some embodiments leverage solubility differences between at least some lithium salts and non-lithium-containing salts. First achieving relatively high concentrations of solubilized lithium cations (and/or non-lithium cations as well) can facilitate such separation processes. Some techniques described below (e.g., osmotic separation, humidification) can in some instances accomplish lithium cation concentration relatively efficiently in terms of energy and/or operational expenditure. In some embodiments, a ratio of a concentration of solubilized lithium cations in the concentrated stream to a concentration of solubilized lithium cations in the feed stream is greater than or equal to 4, greater than or equal to 5, greater than or equal to 10, greater than or equal to 20, greater than or equal to 25, and/or up to 30, up to 40, up to 50, or greater.

In some embodiments, the concentrated stream has a relatively high concentration of solubilized lithium cations. For example, in some embodiments, the concentrated stream has a concentration of solubilized lithium cations of greater than or equal to 40 mg/L, greater than or equal to 50 mg/L, greater than or equal to 100 mg/L, greater than or equal to 200 mg/L, greater than or equal to 500 mg/L, greater than or equal to 1,000 mg/L, greater than or equal to 2,000 mg/L, greater than or equal to 5,000 mg/L, greater than or equal to 10,000 mg/L, greater than or equal to 20,000 mg/L, greater than or equal to 30,000 mg/L, and/or up to 50,000 mg/L, or greater.

In some embodiments, at least some (e.g., at least 5 wt %, at least 10 wt %, at least 20 wt %, at least 50 wt %, at least 80 wt %, at least 90 wt %, at least 95 wt %, at least 99 wt %, or more) of the liquid removed during the removing step is removed using one or more osmotic units. An osmotic unit refers to a collection of components including one or more osmotic membranes configured to perform an osmotic process (e.g., a reverse osmosis process) on at least one input stream and produce at least one output stream. An osmotic unit may comprise at least one osmotic membrane defining a permeate side of the first osmotic unit and a retentate side of the first osmotic unit. For example, referring to FIGS. 1A-1B, 3A-3C, and 6, lithium recovery system 100 comprises osmotic unit 101 comprising retentate side 102 and permeate side 103 and is arranged such that osmotic unit 101 can receive at least a portion of feed stream 104. Each osmotic unit described herein may include further sub-units such as, for example, individual osmotic membrane cartridges, valving, fluidic conduits, and the like. As described in more detail below, each osmotic unit can include a single osmotic membrane or multiple osmotic membranes. In some embodiments, a single osmotic unit can include multiple osmotic sub-units (e.g., multiple osmotic cartridges) that may or may not share a common container.

In some embodiments, an osmotic unit retentate inlet stream (which may comprise at least a portion (e.g., at least 5 wt %, at least 10 wt %, at least 20 wt %, at least 50 wt %, at least 80 wt %, at least 90 wt %, at least 95 wt %, at least 99 wt %, or more) of liquid from the feed stream, optionally via one or more other streams, is transported to a retentate side of the osmotic unit such that an osmotic unit retentate outlet stream exits the retentate side of the osmotic unit, the osmotic unit retentate outlet stream having a concentration of solubilized lithium cations that is greater than a concentration solubilized lithium cations in the osmotic unit retentate inlet stream (e.g., by a factor of at least 1.03, at least 1.035, at least 1.05, at least 1.10, at least 1.25, and/or up to 1.40, up to 1.50, up to 2, up to 3, up to 4, up to 5 or greater). For example, referring again to FIGS. 1A-1B, 3A-3C, and 6, osmotic unit 101 may comprise at least one osmotic membrane defining retentate side 102 and permeate side 103, and osmotic unit retentate inlet stream 105 may be transported to retentate side 102 such that osmotic unit retentate outlet stream 106 exits retentate side 102. The step may be performed such that first osmotic unit retentate outlet stream 106 has a concentration of solubilized ions (e.g., solubilized lithium cations) that is greater than a concentration of solubilized lithium cations in osmotic unit retentate inlet stream 105, according to some embodiments. Unless expressly stated otherwise, the concentration comparisons described in this disclosure are on a mass basis (e.g., g/mL). However, the concentration comparisons could also be expressed on an atomic or molar basis.

In some embodiments, at least a portion (e.g., at least 5 wt %, at least 10 wt %, at least 20 wt %, at least 50 wt %, at least 80 wt %, at least 90 wt %, at least 95 wt %, at least 99 wt %, or more) of liquid from the osmotic unit retentate inlet stream is transported from the retentate side of the osmotic unit, through an osmotic membrane of the osmotic unit, to a permeate side of the osmotic unit. Referring again to FIGS. 1A-1B, 3A-3C, and 6, for example, at least a portion of liquid from osmotic unit retentate inlet stream 105 may be transported from retentate side 102, through an osmotic membrane, to permeate side 103. Liquid transported from the retentate side to the permeate side of the osmotic unit may form some or all of an osmotic unit permeate outlet stream (e.g., osmotic unit permeate outlet stream 107 in FIGS. 1A-1B, 3A-3C, and 6), which may be discharged from the osmotic system (e.g., as substantially pure liquid such as substantially pure water).

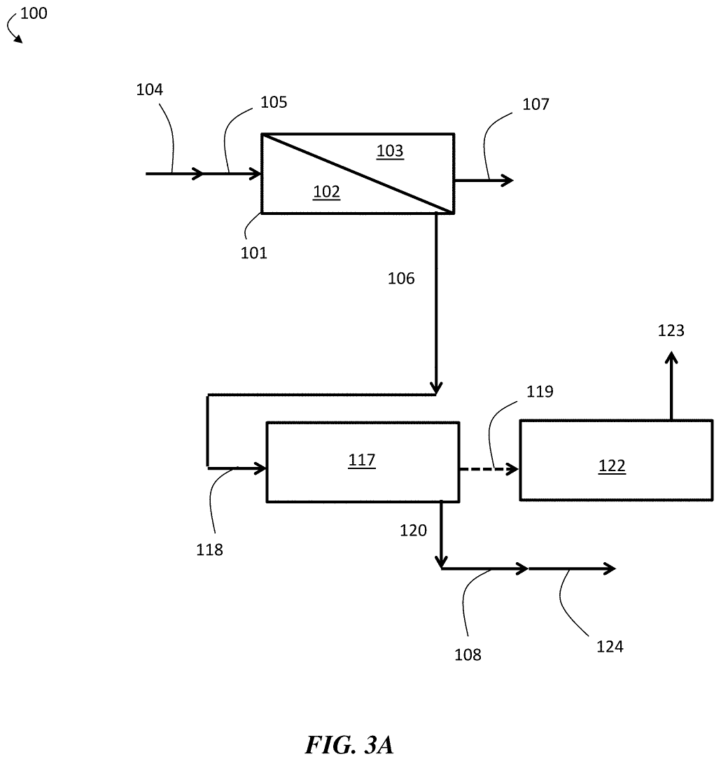

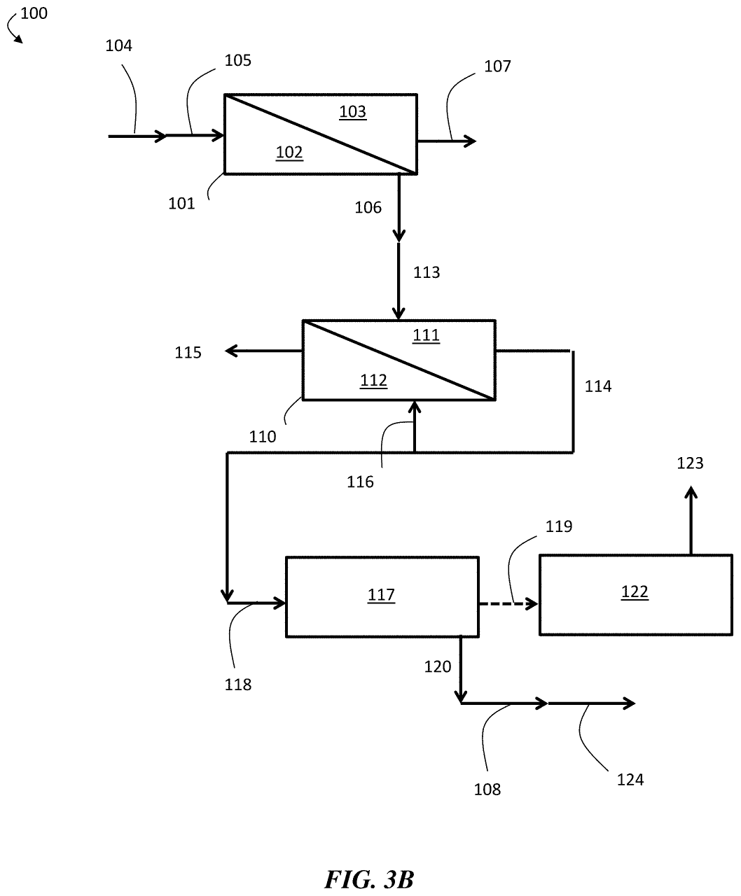

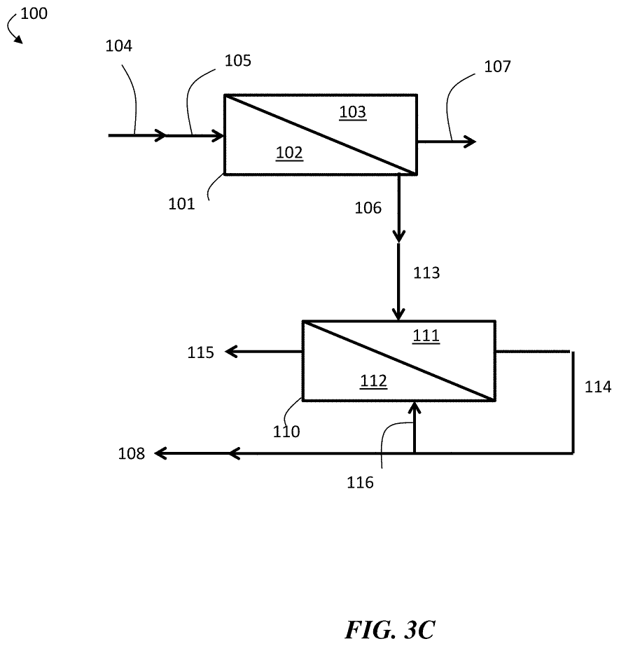

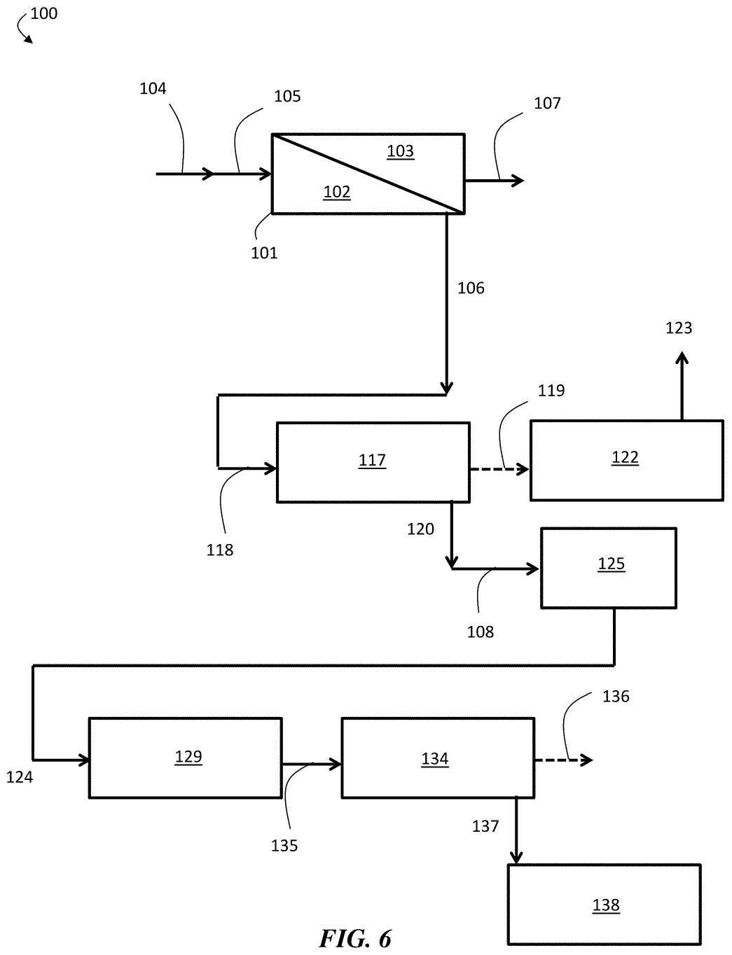

In some embodiments, the method of obtaining lithium (e.g., as a lithium salt) is performed such that at least a portion (e.g., at least 5 wt %, at least 10 wt %, at least 20 wt %, at least 50 wt %, at least 80 wt %, at least 90 wt %, at least 95 wt %, at least 99 wt %, or more) of the osmotic unit retentate outlet stream is part of the concentrated stream. For example, in FIGS. 1A-1B, at least a portion of osmotic unit retentate outlet stream 106 is part of concentrated stream 108. While FIGS. 1A-1B shows osmotic unit retentate outlet stream 106 being directly fed to concentrated steam 108, other arrangements are possible. For example, in some embodiments, the portion of the osmotic unit retentate outlet stream that ultimately becomes part of the concentrated stream first goes through one or more intervening processes (e.g., by being transported through one or more further osmotic units and/or humidifiers such as in FIGS. 3A-3C and 6).

Transport of liquid (e.g., water) through osmotic membrane(s) of osmotic units can be achieved via a transmembrane net driving force (i.e., a net driving force through the thickness of the membrane(s)), according to certain embodiments. Generally, the transmembrane net driving force (Δ_{χ}) is expressed as:

Δ_{χ}=ΔP−ΔΠ=(P₁−P₂)−(Π₁−H₂) [1]

wherein P₁ is the hydraulic pressure on the retentate side of the osmotic membrane, P₂ is the hydraulic pressure on the permeate side of the osmotic membrane, Π₁ is the osmotic pressure of the stream on the retentate side of the osmotic membrane, and Π₂ is the osmotic pressure of the stream on the permeate side of the osmotic membrane. (P₁−P₂) can be referred to as the transmembrane hydraulic pressure difference, and (Π₁−Π₂) can be referred to as the transmembrane osmotic pressure difference.

Those of ordinary skill in the art are familiar with the concept of osmotic pressure. The osmotic pressure of a particular liquid is an intrinsic property of the liquid. The osmotic pressure can be determined in a number of ways, with the most efficient method depending upon the type of liquid being analyzed. For certain solutions with relatively low molar concentrations of ions, osmotic pressure can be accurately measured using an osmometer. In other cases, the osmotic pressure can simply be determined by comparison with solutions with known osmotic pressures. For example, to determine the osmotic pressure of an uncharacterized solution, one could apply a known amount of the uncharacterized solution on one side of a non-porous, semi-permeable, osmotic membrane and iteratively apply different solutions with known osmotic pressures on the other side of the osmotic membrane until the differential pressure through the thickness of the membrane is zero.

The osmotic pressure (17) of a solution containing n solubilized species may be estimated as:

Π=Σⱼ₌₁ⁿiⱼM₁RT [2]

wherein iⱼ is the van′t Hoff factor of the j^{th} solubilized species, Mⱼ is the molar concentration of the j^{th} solubilized species in the solution, R is the ideal gas constant, and T is the absolute temperature of the solution. Equation 2 generally provides an accurate estimate of osmotic pressure for liquid with low concentrations of solubilized species (e.g., concentrations at or below between about 4 wt % and about 6 wt %). For many liquid comprising solubilized species, at species concentrations above around 4-6 wt %, the increase in osmotic pressure per increase in salt concentration is greater than linear (e.g., slightly exponential).

Reverse osmosis generally occurs when the osmotic pressure on the retentate side of the osmotic membrane is greater than the osmotic pressure on the permeate side of the osmotic membrane, and a pressure is applied to the retentate side of the osmotic membrane such that the hydraulic pressure on the retentate side of the osmotic membrane is sufficiently greater than the hydraulic pressure on the permeate side of the osmotic membrane such that the osmotic pressure difference is overcome and solvent (e.g., water) is transported from the retentate side of the osmotic membrane to the permeate side of the osmotic membrane. Generally, such situations result when the transmembrane hydraulic pressure difference (P₁−P₂) is greater than the transmembrane osmotic pressure difference (Π₁−Π₂) such that liquid (e.g., water) is transported from the retentate side of the osmotic membrane to the permeate side of the osmotic membrane (rather than having liquid transported from the permeate side of the osmotic membrane to the first side of the osmotic membrane, which would be energetically favored in the absence of the pressure applied to the retentate side of the osmotic membrane).

In some embodiments, some or all of the osmotic units in the lithium recovery system are configured and operated to perform reverse osmosis (e.g., during methods of obtaining lithium).

In some embodiments, at least a portion of a stream exiting one or more osmotic unit is recirculated and fed back into the same osmotic unit. Such recycle processes may allow for relatively high amounts of liquid to be removed by the osmotic unit (in some instances using fewer system components) prior to further downstream processes compared to some embodiments in which no such recycle occurs.

As one example of a recycle process, in some embodiments the osmotic unit retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the osmotic unit retentate outlet stream. The osmotic unit retentate inlet stream may comprise at least a portion of the osmotic unit retentate outlet stream during at least a period of time (e.g., an entirety or a subset of time) during operation of the osmotic unit as part of the methods described in this disclosure. As an illustrative example, the embodiment shown in FIG. 1B shows a portion of osmotic unit retentate outlet stream 106 being transported back to osmotic unit retentate inlet stream 105 as recycle stream 109. Recycle stream 109 may be combined with feed stream 104 to form at least part of osmotic unit retentate inlet stream 105. However, in some embodiments, such as during certain of the batch processes described below, the recycle stream comprising at least a portion of the osmotic unit retentate outlet stream is not mixed with the feed stream prior to or during incorporation of that portion of the osmotic unit retentate outlet stream into the osmotic unit retentate inlet stream. For example, in some embodiments, during at least a period of time during the liquid removal process, the osmotic unit retentate inlet stream comprises at least a portion of the osmotic unit retentate outlet stream, but less than or equal to 20 wt %, less than or equal to 10 wt %, less than or equal to 5 wt %, less than or equal to 2 wt %, less than or equal to 1 wt %, less than or equal to 0.1 wt %, or none of the osmotic unit retentate inlet stream is from the feed stream during that period of time.

During a recycle process, in accordance with some embodiments, at least some (or all) of a remainder of the osmotic unit retentate outlet stream not recirculated back to the retentate side of the osmotic unit may become a part (or all) of the concentrated stream. In some embodiments, a hydraulic pressure of the recycle stream may be increased (e.g., by at least 5%, at least 10%, at least 20%, at least 50%, at least 80%, at least 90%, at least 95%, at least 99%, or more) prior to becoming part of the osmotic unit retentate inlet stream. Such an increase in pressure can be accomplished using any of a variety of techniques, such as using a pump. In some instances, a recycle process involving an osmotic unit (e.g., incorporating a portion of the osmotic unit retentate outlet stream into the osmotic unite retentate inlet stream) is performed in a batch manner. In some embodiments, a recycle process is performed in a continuous manner. In some embodiments, a recycle process is performed using a semi-batch process. Batch operation, semi-batch operation, and continuous operation of osmotic units are generally known. During batch operation, a hydraulic pressure of the osmotic unit retentate inlet stream is increased over time during operation, as quantities of streams are fed to the retentate side inlet stream. It has been realized in the context of this disclosure that batch or semi-batch operation of a process involving an osmotic unit (e.g., a recycle process) can reduce an amount of energy required to operate the osmotic unit by gradually increasing a concentration (and in some instances the hydraulic pressure) of the osmotic unit retentate inlet stream rather than maintaining an entirety of the osmotic unit's streams at a high pressure, as is generally the case during continuous operation. Such a reduction in energy usage may allow for lithium recovery with greater energy efficiency and/or lower cost than typical existing lithium recovery technologies.

In some embodiments, at least some (e.g., at least 5 wt %, at least 10 wt %, at least 20 wt %, at least 50 wt %, at least 80 wt %, at least 90 wt %, at least 95 wt %, at least 99 wt %, or more) of the liquid removed from the feed stream during the removing step is performed using one or more humidifiers. A humidifier of may have any configuration that allows for the production of a gaseous stream comprising vapor (e.g., water vapor) transferred from a liquid stream (e.g., a stream comprising liquid water) via an evaporation process. In some embodiments, the humidifier is configured to produce such a gaseous stream comprising vapor (e.g., a “humidified gas stream”) by transferring the vapor (e.g., water vapor) from the liquid stream (e.g., a stream comprising liquid water) to a carrier gas via an evaporation process. In some embodiments, the humidifier comprises a liquid inlet configured to receive the liquid stream and/or a gas inlet configured to receive the carrier gas. The humidifier may further comprise a liquid outlet and/or a gas outlet. In certain embodiments, the carrier gas comprises a non-condensable gas. Non-limiting examples of suitable non-condensable gases include air, nitrogen, oxygen, helium, argon, carbon monoxide, carbon dioxide, sulfur oxides (SOₓ) (e.g., SO₂, SO₃), and/or nitrogen oxides (NOₓ) (e.g., NO, NO₂). Examples of potentially suitable humidifiers include, but are not limited to bubble column humidifiers and packed bed humidifiers, further details of which are provided below.

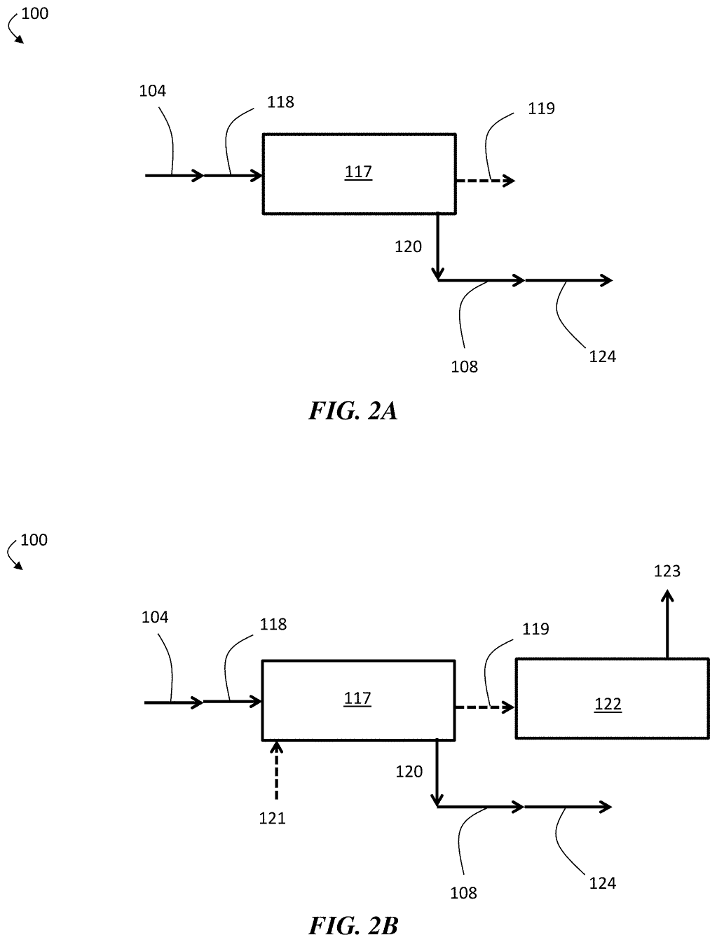

In some embodiments, the process of removing liquid from the feed stream comprises transporting a humidifier liquid inlet stream comprising at least a portion (e.g., at least 5 wt %, at least 10 wt %, at least 20 wt %, at least 50 wt %, at least 80 wt %, at least 90 wt %, at least 95 wt %, at least 99 wt %, or more) of the feed stream to a humidifier (e.g., via a humidifier liquid inlet). FIG. 2A shows a schematic diagram of an embodiment of lithium recovery system 100 comprising humidifier 117. In the embodiment shown in FIG. 2A, at least a portion of feed stream 104 forms some (e.g., at least 5 wt %, at least 10 wt %, at least 20 wt %, at least 50 wt %, at least 80 wt %, at least 90 wt %, at least 95 wt %, at least 99 wt %, or more) or all of humidifier liquid inlet stream 118.

In some embodiments, at least a portion (e.g., at least 5 wt %, at least 10 wt %, at least 20 wt %, at least 50 wt %, at least 80 wt %, at least 90 wt %, at least 95 wt %, at least 99 wt %, or more) of liquid of the humidifier liquid inlet stream is allowed to evaporate within the humidifier (e.g., within a vessel of the humidifier) to produce a humidified gas stream and a humidifier liquid outlet stream. Referring again to FIG. 2A, for example, at least a portion of liquid of humidifier liquid inlet stream 118 may be allowed to evaporate within humidifier 117 to produce humidified gas stream 119 (comprising at least a portion of vapor produced by the evaporation) and humidifier liquid outlet stream 120. In some instances, the humidified gas stream is produced by transporting a gas stream (e.g., comprising a carrier gas) to the humidifier (e.g., via a humidifier gas inlet) and transferring at least some of the vapor formed by the evaporation into the gas stream. For example, FIG. 2B shows gas stream 121 entering humidifier 117, where carrier gas of the gas stream 121 may be contacted with liquid of humidifier liquid inlet stream 118, thereby transferring liquid (e.g., in vapor form) to the gas stream to form humidified gas stream 119.

The humidifier liquid outlet stream may have a higher concentration of solubilized lithium cations compared to the humidifier liquid inlet stream. In some embodiments, the humidifier liquid outlet stream has a higher concentration of solubilized lithium cations than does the humidifier liquid inlet stream by a factor of at least 1.03, at least 1.05, at least 1.1, at least 1.2, at least 1.25, and/or up to 1.5, up to 2, up to 4, up to 5, or more. As mentioned above, increasing a concentration of solubilized lithium ions may facilitate downstream separation processes, such as processes involving removal of non-lithium cations (e.g., by selective thermal precipitation).

In some embodiments, the method of obtaining lithium (e.g., as a lithium salt) is performed such that at least a portion (e.g., at least 5 wt %, at least 10 wt %, at least 20 wt %, at least 50 wt %, at least 80 wt %, at least 90 wt %, at least 95 wt %, at least 99 wt %, or more) of the humidifier liquid outlet stream is part of the concentrated stream. For example, in FIGS. 2A-3B and 6, at least a portion of humidifier liquid outlet stream 120 is part of concentrated stream 108. While FIGS. 2A-3B and 6 show humidifier liquid outlet stream 120 being directly fed to concentrated steam 108, other arrangements are possible. For example, in some embodiments, the portion of the osmotic unit retentate outlet stream that ultimately becomes part of the concentrated stream first goes through one or more intervening processes (e.g., by being transported through one or more further humidifiers and/or osmotic units).

In some embodiments, the humidifier is part of a humidification-dehumidification (HDH) apparatus that also comprises a dehumidifier. In some embodiments, the process of removing liquid from the feed stream further comprises condensing at least a portion (e.g., at least 5 wt %, at least 10 wt %, at least 20 wt %, at least 50 wt %, at least 80 wt %, at least 90 wt %, at least 95 wt %, at least 99 wt %, or more) of the liquid within the humidified gas within a dehumidifier to produce a condensed liquid stream. The dehumidifier may be configured to receive the humidified gas stream from the humidifier. In some embodiments in which the liquid comprises water, the dehumidifier may be configured to transfer at least a portion of the water (e.g., water vapor) from the humidified gas stream to a substantially pure water stream through a condensation process, thereby producing a substantially pure water stream. In FIGS. 2B-3B and 6, lithium recovery system 100 comprises dehumidifier 122, which is configured to receive (e.g., via one more fluidic conduits) at least a portion (e.g., at least 5 wt %, at least 10 wt %, at least 20 wt %, at least 50 wt %, at least 80 wt %, at least 90 wt %, at least 95 wt %, at least 99 wt %, or more) of humidified gas stream 119. Condensed liquid from humidified gas stream 119 produced in dehumidifier 122 may form some (e.g., at least 5 wt %, at least 10 wt %, at least 20 wt %, at least 50 wt %, at least 80 wt %, at least 90 wt %, at least 95 wt %, at least 99 wt %, or more) or all of condensed liquid stream 123 (e.g., substantially pure water). Any of a variety of dehumidifiers may be used. For example, the dehumidifier may comprise a bubble column dehumidifier, which is described in greater detail below. It has been realized that some such configurations involving coupling dehumidifiers to humidifiers during at least a portion of lithium recovery may allow for production of commercially valuable resources such as substantially pure water simultaneously (or sequentially) with obtaining lithium (e.g., lithium salts). Such a process may help obtain greater commercial value from recovering lithium from certain feed stream sources (e.g., brines) compared to typical lithium recovery technologies.

In some embodiments, the process of removing liquid from the feed stream (e.g., comprising the liquid, solubilized lithium cations, and solubilized non-lithium cations) is performed using both an osmotic unit and a humidifier. In some embodiments, the osmotic unit and the humidifier are arranged fluidically in series. For example, in some embodiments, the humidifier liquid inlet stream comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the osmotic unit retentate outlet stream. As an illustrative example, FIG. 3A shows an embodiment of lithium recovery system 100 where at least a portion of osmotic unit retentate outlet stream 106 (comprising at least a portion of feed stream 104 treated in osmotic unit 101) is transferred to humidifier 117 (e.g., via one or more conduits) by forming some (e.g., at least 5 wt %, at least 10 wt %, at least 20 wt %, at least 50 wt %, at least 80 wt %, at least 90 wt %, at least 95 wt %, at least 99 wt %, or more) or all of humidifier liquid inlet stream 118. It has been realized in the context of this disclosure that a process involving liquid removal by osmotic separation followed by humidification can, in some instances, achieve ion concentration (e.g., lithium cation concentration) to a greater extent and/or with a greater efficiency than achievable with either technique alone. For example, an osmotic separation process may be well-suited for concentrating initial feed streams source from, for example, brines. Such an osmotic concentration of the feed stream may result in relatively high concentrations of solubilized ions that are better-suited for further concentration using a humidifier compared to additional osmotic separation. For example, reverse osmosis can require greater and greater hydraulic pressures as ion concentrations increase, thereby requiring greater and greater energy expenditure and/or wear and tear on equipment. It has been realized that concentration via humidifiers may not necessarily experience the same adverse effects at higher ion concentrations. Additionally, streams with higher concentrations of solubilized species tend to have greater viscosity than streams having comparatively lower concentrations of solubilized species. It has been observed in the context of this disclosure that in some instances humidifiers are better suited for use with more viscous solutions than are osmotic systems. Moreover, streams with higher concentrations of solubilized species tend to have reduced flux in osmotic systems due in part to the higher viscosity and/or increased concentration polarization. Therefore, an initial concentration process with an osmotic system and further concentration of the more concentrated output (having higher viscosity) with a humidifier can reduce or avoid such adverse effects compared to further concentration with an osmotic system.

While the above disclosure describes a series configuration of the osmotic unit and the humidifier, other arrangements are possible. For example, in some embodiments, the osmotic unit and the humidifier are arranged in parallel, such that (a) the osmotic unit retentate inlet stream comprises a first portion of the feed stream, and (b) the humidifier liquid inlet stream comprises a second portion of the feed stream. In some embodiments, the concentrated stream is produced at least in part by combining at least a portion of the osmotic unit retentate outlet stream and at least a portion of the humidifier liquid outlet stream.

While in some embodiments the methods described herein employ a single osmotic unit for removing the liquid from the feed stream (e.g., as shown in FIGS. 1A and 3A), in some embodiments multiple osmotic units are employed. For example, the osmotic unit described above may be a first osmotic unit, and a second osmotic unit may be used to further remove liquid from one or more streams. Use of a first osmotic unit and a second osmotic unit can promote, in some instances, effective removal of liquid from a feed stream by providing tunability of flow rates and hydraulic pressures for each osmotic unit based on, for example, ion concentrations of streams fed to each unit. In some embodiments in which the osmotic unit is a first osmotic unit, the osmotic unit retentate outlet stream is a first osmotic unit outlet stream, and the process of removing liquid from the feed stream further comprises transporting a second osmotic unit retentate inlet stream comprising at least a portion of the first osmotic unit retentate outlet stream to a retentate side of a second osmotic unit. The second osmotic unit may comprise at least one osmotic membrane defining a permeate side of the second osmotic unit and a retentate side of the second osmotic unit.

In some embodiments, the second osmotic unit retentate inlet stream (which may comprise at least a portion (e.g., at least 5 wt %, at least 10 wt %, at least 20 wt %, at least 50 wt %, at least 80 wt %, at least 90 wt %, at least 95 wt %, at least 99 wt %, or more) of liquid from the first osmotic unit retentate outlet stream (in some instances via one or more other streams) is transported to a retentate side of the second osmotic unit such that a second osmotic unit retentate outlet stream exits the retentate side of the second osmotic unit, the second osmotic unit retentate outlet stream having concentration of solubilized lithium cations that is greater than a concentration of solubilized lithium cations of the second osmotic unit retentate inlet stream (e.g., by a factor of at least 1.03, at least 1.035, at least 1.05, at least 1.10, at least 1.25, and/or up to 1.40, up to 1.50, up to 2, up to 3, up to 4, up to 5, up to 6, or greater). For example, referring to FIG. 3B, second osmotic unit 110 may comprise at least one osmotic membrane defining retentate side 111 and permeate side 112, and second osmotic unit retentate inlet stream 113 may be transported to retentate side 111 such that second osmotic unit retentate outlet stream 114 exits retentate side 111. The step may be performed such that second osmotic unit retentate outlet stream 114 has a concentration of solubilized lithium cations that is greater than a concentration of solubilized lithium cations in the second osmotic unit retentate inlet stream 113.

In some embodiments, at least a portion (e.g., at least 5 wt %, at least 10 wt %, at least 20 wt %, at least 50 wt %, at least 80 wt %, at least 90 wt %, at least 95 wt %, at least 99 wt %, or more) of liquid from the second osmotic unit retentate inlet stream is transported from the retentate side of the second osmotic unit, through an osmotic membrane of the second osmotic unit, to a permeate side of the second osmotic unit. Referring again to FIG. 3B, for example, at least a portion of liquid from second osmotic unit retentate inlet stream 113 may be transported from retentate side 111, through an osmotic membrane, to permeate side 112. Liquid transported from the retentate side to the permeate side of the second osmotic unit may form some (e.g., at least 5 wt %, at least 10 wt %, at least 20 wt %, at least 50 wt %, at least 80 wt %, at least 90 wt %, at least 95 wt %, at least 99 wt %, or more) or all of a second osmotic unit permeate outlet stream (e.g., second osmotic unit permeate outlet stream 115 in FIG. 3B). The second unit permeate outlet stream may be recirculated to an earlier stream in the system. For example, in some embodiments, the first osmotic unit retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the second osmotic unit permeate outlet stream.

In some, but not necessarily all embodiments, a second osmotic unit permeate inlet stream is transported to the permeate side of the second osmotic unit. In some embodiments, liquid transported from the retentate side to the permeate side of the second osmotic unit is combined with the second osmotic unit permeate inlet stream to form the second osmotic unit permeate outlet stream. The second osmotic unit permeate outlet stream may be transported out of the permeate side, e.g., for further processing, recycling, discharge, or combinations thereof. As an example, in the embodiment shown in FIG. 3B, second osmotic unit permeate inlet stream 116 is transported to permeate side 112 of second osmotic unit 110, where it can be combined with liquid transported from second osmotic unit retentate inlet stream 113 that has passed through an osmotic membrane, to form second osmotic unit permeate outlet stream 115. As such, second osmotic unit permeate outlet stream 115 may have a lower concentration of solubilized ions than that of second osmotic unit permeate inlet stream 116. In some embodiments, the second osmotic unit permeate inlet stream serves as a draw stream comprising a draw solution, non-limiting examples of compositions of which are described in further detail below. A draw stream (e.g., from second osmotic unit permeate inlet stream 116) may, in accordance with certain embodiments, reduce the hydraulic pressure necessary for a reverse osmosis process to be performed at the second osmotic unit (e.g., when the draw stream has an osmotic pressure such that a lower hydraulic pressure is required to achieve a given transmembrane net driving force relative to operation without the draw stream). In some embodiments, the osmotic system is operated such that the second osmotic unit permeate inlet stream has a hydraulic pressure of less than or equal to 250 psi (less than or equal to 1.72×10³ kPa), less than or equal to 200 psi (less than or equal to 1.38×10³ kPa), less than or equal to 100 psi (less than or equal to 6.90×10² kPa), and/or as low as 50 psi (as low as 3.45×10² kPa), or less.

In some embodiments in which the osmotic system includes a second osmotic unit permeate inlet stream, the second osmotic unit permeate inlet stream comprises a portion (e.g., at least 5 wt %, at least 10 wt %, at least 20 wt %, at least 50 wt %, at least 80 wt %, at least 90 wt %, at least 95 wt %, at least 99 wt %, or more) of the second osmotic unit retentate outlet stream. Such a configuration may, in some instances, contribute to beneficial performance of the osmotic system by providing a relatively low-pressure draw stream with dissolved solute, the presence of which may reduce the hydraulic pressure required at the retentate side for performing a reverse osmosis process (thereby saving energy and/or increasing system durability). As an illustrative example, in FIG. 3B, some (e.g., at least 5 wt %, at least 10 wt %, at least 20 wt %, at least 50 wt %, at least 80 wt %, at least 90 wt %, at least 95 wt %, at least 99 wt %, or more) of second osmotic unit retentate outlet stream 114 may be transported (e.g., via one or more fluidic conduits) to permeate side 112 of second osmotic unit 110 by forming some or all of second osmotic unit permeate inlet stream 116 (which can serve as a draw stream). However, sources for the second osmotic unit permeate inlet stream other than the second osmotic unit retentate outlet stream may be used.

In some embodiments, the method of obtaining lithium (e.g., as a lithium salt) is performed such that at least a portion (e.g., at least 5 wt %, at least 10 wt %, at least 20 wt %, at least 50 wt %, at least 80 wt %, at least 90 wt %, at least 95 wt %, at least 99 wt %, or more) of the second osmotic unit retentate outlet stream is part of the concentrated stream. For example, in FIG. 3B, at least a portion of second osmotic unit retentate outlet stream 114 is part of concentrated stream 108 following treatment in humidifier 117. While FIG. 3B shows second osmotic unit retentate outlet stream 114 being indirectly fed to concentrated steam 108, other arrangements are possible. For example, in some embodiments, the second osmotic unit retentate outlet stream is fed directly to the concentrated stream.

In some embodiments in which the osmotic unit and the humidifier are arranged in series, the second osmotic unit is also employed, such that the humidifier liquid inlet stream comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the second osmotic unit retentate outlet stream. For example, FIG. 3B shows an embodiment of lithium recovery system 100 where at least a portion of second osmotic unit retentate outlet stream 114 is transferred to humidifier 117 by forming some (e.g., at least 5 wt %, at least 10 wt %, at least 20 wt %, at least 50 wt %, at least 80 wt %, at least 90 wt %, at least 95 wt %, at least 99 wt %, or more) or all of humidifier liquid inlet stream 118.

It should be understood that while FIG. 3B shows an embodiment in which system 100 includes first osmotic unit 101, second osmotic unit 110, and humidifier 117, the presence of a humidifier in a system comprising a first osmotic unit and a second osmotic unit is not required. For example, FIG. 3C shows a schematic diagram of system 100 comprising first osmotic unit 101 and second osmotic unit 110 configured in the same manner as in the embodiment shown in FIG. 3B. In some embodiments, system 100 as shown in FIG. 3C can be used to form concentrated stream 108, which comprises at least a portion (e.g., at least 5 wt %, at least 10 wt %, at least 20 wt %, at least 50 wt %, at least 80 wt %, at least 90 wt %, at least 95 wt %, at least 99 wt %, or more) of second osmotic unit retentate outlet stream 114 and has a higher concentration of solubilized lithium ions than feed stream 104. In some embodiments, at least a portion (e.g., at least 5 wt %, at least 10 wt %, at least 20 wt %, at least 50 wt %, at least 80 wt %, at least 90 wt %, at least 95 wt %, at least 99 wt %, or more) of concentrated stream 108 from FIG. 3C is subjected to further treatment (e.g., by removing at least some of any non-lithium cations present in concentrated stream as described elsewhere in this disclosure). In some embodiments, at least a portion (e.g., at least 5 wt %, at least 10 wt %, at least 20 wt %, at least 50 wt %, at least 80 wt %, at least 90 wt %, at least 95 wt %, at least 99 wt %, or more) of concentrated stream 108 is used directly for any of a variety of desired applications. Such desired applications include, but are not limited to, production of lithium metal, use as a desiccant, production of pyrotechnics, and production of medical agents (e.g., lithium-containing pharmaceutical agents).

As mentioned above, some methods for obtaining lithium (e.g., as a lithium salt) comprise removing at least some (e.g., at least 5 wt %, at least 10 wt %, at least 20 wt %, at least 50 wt %, at least 80 wt %, at least 90 wt %, at least 95 wt %, at least 99 wt %, or more) of the solubilized non-lithium cations (e.g., sodium cations, potassium cations, magnesium cations, calcium cations) from the concentrated stream to form an impurity-depleted concentrated stream. Such a process can be advantageous in a lithium recovery process because it can result in a stream having a relatively high concentration of lithium cations compared to a concentration of non-lithium cations, which may be considered impurities in applications in which a substantially pure form of lithium (e.g., a lithium salt) is desired. In the context of this disclosure, any material that is not and does not contain lithium is considered an impurity. For example, lithium cations and lithium salts are not considered impurities, but all other non-solvent components are considered impurities. Referring to FIGS. 1A-3B and 6, some methods may comprise removing at least some of the solubilized non-lithium cations in concentrated stream 108 (e.g., via one or more ion removal processes not pictured), thereby forming impurity-depleted concentrated stream 124.

In some embodiments, the impurity-depleted concentrated stream has a lower concentration of the solubilized non-lithium cation compared to the concentrated stream. For example, in some embodiments, a ratio of a concentration of a non-lithium cation (e.g., sodium cation, potassium cation, magnesium cation, or calcium cation) in the concentrated stream to the concentration of that non-lithium cation in the impurity-depleted concentrated stream is greater than or equal to 1.1, greater than or equal to 1.2, greater than or equal to 1.5, greater than or equal to 2, greater than or equal to 5, greater than or equal to 10, greater than or equal to 20, greater than or equal to 50, greater than or equal to 100, and/or up to 200, up to 500, up to 1,000, or greater. In some embodiments, a ratio of a total concentration of all non-lithium cations (e.g., a sum of the concentration of sodium cations, potassium cations, magnesium cations, calcium cations) in the concentrated stream to the total concentration of all non-lithium cations in the impurity-depleted concentrated stream is greater than or equal to 1.1, greater than or equal to 1.2, greater than or equal to 1.5, greater than or equal to 2, greater than or equal to 5, greater than or equal to 10, greater than or equal to 20, greater than or equal to 50, greater than or equal to 100, and/or up to 200, up to 500, up to 1,000, or greater.

In some embodiments in which at least some of the solubilized non-lithium cations are removed from the concentrated stream to form the impurity-depleted concentrated stream, both the absolute concentration of the non-lithium cations and the absolute concentration of the lithium cations are increased with respect to the concentrated stream, but the absolute concentration of the lithium ions increases to a greater extent than the absolute concentration of the non-lithium ions. As such, use of the term “impurity-depleted concentrated stream” does not necessarily mean that an absolute concentration of non-lithium cations in the liquid is lowered. Such an increase in concentration of non-lithium cations despite removal of at least some of the non-lithium cations can occur, for example, via concentration-induced precipitation. For example, the non-lithium cations may be solubilized in the concentrated stream at a concentration below a saturation point for those non-lithium cations. During the removal process, such a concentrated stream may be subjected to a liquid removal process and/or heating process (e.g., via boiling) such that the non-lithium cations are concentrated to the point of saturation. At saturation, precipitates of salts comprising at least some of the non-lithium cations may be formed and separated from the stream, thereby removing at least some of the non-lithium cations from the stream while the concentration of the non-lithium cations remains at the saturation point. Meanwhile, the lithium cations may also be solubilized in the concentrated stream at a concentration below a saturation point for the lithium cations. During the same removal process where the concentrated stream is subjected to a liquid removal process to form the impurity-depleted concentrated stream, the lithium cations are also concentrated, but to a greater extent than the non-lithium cations because the lithium cations have a higher saturation point than the non-lithium cations under the operative conditions. Therefore, the lithium cations may continue to be concentrated while the concentration of the non-lithium cations reaches and remains at their saturation point as at least some of the non-lithium cations are removed via precipitation.

In some embodiments, the process of the process of removing at least some of the solubilized non-lithium cations from the concentrated stream forms an impurity-depleted concentrated stream having an atomic ratio of lithium cations to non-lithium cations that is larger than an atomic ratio of lithium cations to non-lithium cations in the concentrated stream. In some embodiments, during the process of removing at least some of the solubilized non-lithium cations from the concentrated stream, a greater amount of the solubilized non-lithium cations is removed compared to any amount of solubilized lithium cation that is removed (which may none or a non-zero amount). Such a selective removal of non-lithium cations with respect to lithium cations may result in a lithium-enriched stream useful for obtaining relatively pure lithium-containing products (e.g., lithium salts). In some embodiments, little to no amount of solubilized lithium cations are removed during such a process, while in some embodiments a concentration of solubilized lithium cations is increased (e.g., due to a reduction in liquid volume). In some embodiments, a ratio of a concentration of solubilized lithium cations in the concentrated stream to the concentration of solubilized lithium cations in the impurity-depleted concentrated stream is less than or equal to 1.05, less than or equal to 1.02, less than or equal to 1, less than or equal to 0.9, less than or equal to 0.8, less than or equal to 0.5, less than or equal to 0.2, less than or equal to 0.1, and/or as low as 0.01, or less. In some embodiments, a ratio of a total concentration of all solubilized non-lithium cation (e.g., sodium cation, potassium cation, magnesium cation, or calcium cation) in the concentrated stream to the total concentration of all solubilized non-lithium cations in the impurity-depleted concentrated stream is greater than or equal to 1.1, greater than or equal to 1.2, greater than or equal to 1.5, greater than or equal to 2, greater than or equal to 5, greater than or equal to 10, greater than or equal to 20, greater than or equal to 50, greater than or equal to 100, and/or up to 200, up to 500, up to 1,000, or greater, while a ratio of a concentration of solubilized lithium cations in the concentrated stream to the concentration of solubilized lithium cations in the impurity-depleted concentrated stream is less than or equal to 1.05, less than or equal to 1.02, less than or equal to 1, less than or equal to 0.9, less than or equal to 0.8, less than or equal to 0.5, less than or equal to 0.2, less than or equal to 0.1, and/or as low as 0.01, or less. In some embodiments, the process of removing at least some of the solubilized non-lithium cations from the concentrated stream results in a ratio of a concentration of solubilized lithium cations to a total concentration of all solubilized non-lithium cations in the impurity-depleted concentrated stream that is greater than that in the concentrated stream by a factor of at least 1.1, at least 1.2, at least 1.5, at least 2, at least 5, at least 10, at least 20, at least 50, at least 100, at least 200, at least 500, and/or up to 1,000, up to 10,000, or greater. As would be readily understood, these ranges may also be expressed in terms of atomic ratios rather than ratios of concentrations. For example, in addition to or instead of satisfying the above ratios of concentrations on a mass basis, in some embodiments the process of removing at least some of the solubilized non-lithium cations from the concentrated stream results in an atomic ratio of solubilized lithium cations to total solubilized non-lithium cations in the impurity-depleted concentrated stream that is greater than that in the concentrated stream by a factor of at least 1.1, at least 1.2, at least 1.5, at least 2, at least 5, at least 10, at least 20, at least 50, at least 100, at least 200, at least 500, and/or up to 1,000, up to 10,000, or greater.

Any of a variety of suitable techniques may be used to remove the solubilized non-lithium cations from the concentrated stream to a greater extent than the solubilized lithium cations. In some embodiments, at least a portion (e.g., at least 5 wt %, at least 10 wt %, at least 20 wt %, at least 50 wt %, at least 80 wt %, at least 90 wt %, at least 95 wt %, at least 99 wt %, or more) of non-lithium cations removed from the concentrated stream during production of the impurity-depleted concentrated stream are removed as solid non-lithium-containing salts comprising at least a portion of the non-lithium cations. Other techniques for the removal of non-lithium cations that can be used include, but are not limited to, extraction (e.g., liquid-liquid extraction, solvent extraction, extraction with compounds and/or solvents with preferential affinity for non-lithium cations) and membrane-based techniques (e.g., dialysis, electrodialysis, nanofiltration). Removing non-lithium cations as solid non-lithium-containing salts may be advantageous in some instances where ease of separation of non-lithium and lithium-containing materials is desired, and in some instances where concentrations of non-lithium ions are relatively high (such as following the liquid removal steps described above, in some embodiments). Removing solid non-lithium-containing salts may be convenient in some instances, as doing so may simply require collection of a mother liquor/supernatant following solid non-lithium-containing salt removal.

Any of a variety of non-lithium-containing salts may be formed from one or more solutions (e.g., streams) described in this disclosure, depending on the composition of the solution. In some embodiments, the non-lithium-containing salt comprises a cation chosen from one or more of sodium and potassium and an anion chosen from one or more of chloride, sulfate, carbonate, bicarbonate, nitrate, borate, phosphate, bromide, citrate, oxide, and hydride. For example, in some embodiments where the concentrated stream comprises solubilized sodium and potassium cations and solubilized chloride anions, an amount of solid sodium chloride and/or potassium chloride may be removed from the concentrated stream during production of the impurity-depleted concentrated stream.

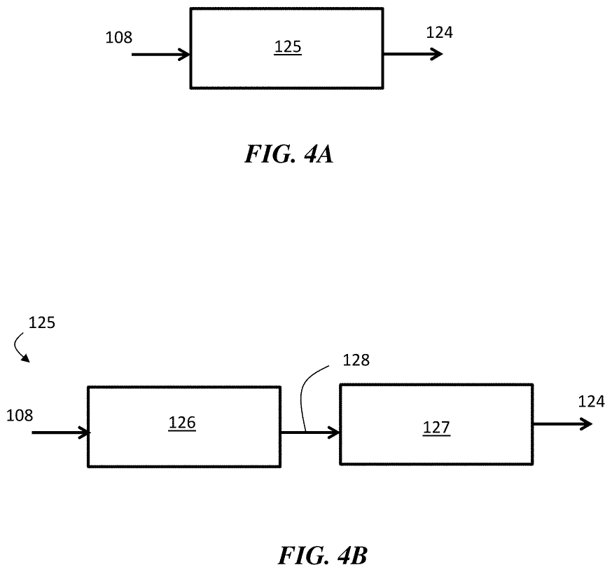

In some embodiments, at least a portion (e.g., at least 5 wt %, at least 10 wt %, at least 20 wt %, at least 50 wt %, at least 80 wt %, at least 90 wt %, at least 95 wt %, at least 99 wt %, or more) of the solid non-lithium-containing salt is formed via precipitation from the concentrated stream (or a stream comprising at least a portion of the concentrated stream). In some embodiments, the solid non-lithium-containing salt is formed via crystallization from the concentrated stream (or a stream comprising at least a portion of the concentrated stream). Precipitation and/or crystallization of the non-lithium-containing salt may occur in a non-lithium-containing salt production unit. In the embodiment shown in FIG. 4A, for example, at least a portion of concentrated stream 108 may be fed to non-lithium-containing salt production unit 125, where an amount of non-lithium-containing salt comprising at least a portion of the non-lithium cations is formed, thereby forming impurity-depleted concentrated stream 124. A non-lithium-containing salt production unit may comprise one or more vessels for receiving at least a portion of a liquid stream (e.g., via a liquid inlet). In some embodiments, a non-lithium-containing salt production unit comprises a heater in thermal communication with the vessel (e.g., for elevating a temperature of a liquid within a vessel). In some embodiments, a non-lithium-containing salt production unit comprises a cooling apparatus in thermal communication with the vessel (e.g., for lowering a temperature of a liquid within the vessel). In some embodiments, the non-lithium-containing salt production unit comprises a precipitation unit configured to induce precipitation and/or crystallization. Examples of apparatuses suitable for non-lithium-containing salt production (e.g., via precipitation) include, but are not limited to, forced circulation evaporators, solvent extraction apparatuses, froth flotation devices, electrodialysis devices, and low-temperature eutectic freeze crystallization apparatuses. In some embodiments, the non-lithium-containing salt production unit comprises a cooling unit (e.g., a chiller) fluidically connected to the precipitation apparatus. For example, in FIG. 4A, non-lithium-containing salt production unit 125 comprises precipitation unit 126 fluidically connected to cooling unit 127.

One process for inducing precipitation of a non-lithium-containing salt is to remove non-lithium-containing salts from solutions comprising lithium and non-lithium cations via chemical treatment. Such chemical treatment may result in selective precipitation of non-lithium-containing salts relative to lithium salts due to different solubilities of lithium and non-lithium-containing salts under certain conditions. One such example is addition of aluminum sulfates to solutions comprising solubilized lithium cations and non-lithium cations such as alkalis or alkaline earth metals. Addition of aluminum sulfate can result in precipitation of non-lithium-containing sulfate salts (e.g., alunite and/or alum) to a greater extent than any lithium-containing sulfates.

A different approach to selective precipitation of non-lithium-containing salts is to vary the temperature of the liquid comprising the solubilized lithium and non-lithium cations. Such a process may be performed without chemically treating the concentrated stream. The solubility of lithium salts and non-lithium-containing salts are generally temperature-dependent. However, the solubility of at least some lithium salts may be greater and vary with temperature to a greater extent than do at least some non-lithium-containing salts. For example, in going from 20° C. to 140° C., the solubility of lithium chloride (LiCl) in water increases from approximately 80 g/100 g of water to approximately 140 g/100 g of water—an increase in solubility of ˜75%. However, in going from 20° C. to 140° C., the solubility of potassium chloride (KCl) in water only increases from approximately 39 g/100 g water to approximately 65 g/100 g water—an increase of only 67% from a lower absolute value than that of lithium chloride. Even more starkly, the solubility of sodium chloride (NaCl) in water only increases from approximately 39 g/100 g water to approximately 42 g/100 g water—an increase of only about 8% from a lower absolute value than that of lithium chloride. Therefore, elevating the temperature of aqueous solutions comprising lithium cations, potassium cations, sodium cations, and chloride anions to sufficiently high temperatures (e.g., by boiling and/or evaporating at least some of the aqueous solution) can cause precipitation of potassium chloride and sodium chloride to a greater extent compared to any precipitation of lithium chloride. As a result, the remaining aqueous solution may be enriched in lithium cations compared to any remaining potassium cations or sodium cations.

Accordingly, in some embodiments, removing at least some of the solubilized non-lithium cations from the concentrated stream (e.g., comprising a liquid such as water, solubilized lithium cations, and solubilized non-lithium cations) comprises elevating a temperature of the concentrated stream to form a heated concentrated stream such that an amount of a solid non-lithium-containing salt comprising at least a portion of the non-lithium cations is formed. In some such embodiments, the heated stream has a temperature of greater than or equal to 100° C., greater than or equal to 110° C., greater than or equal to 120° C., greater than or equal to 140° C., and/or up to 160° C., or higher. In some embodiments, a temperature of the heated concentrated stream is greater than a temperature of the concentrated stream by at least 5° C., at least 10° C., at least 20° C., at least 50° C., at least 100° C., at least 120° C., at least 140° C., and/or up to 150° C. or more.

Any of a variety of techniques and suitable equipment may be used to elevate the temperature of the concentrated stream such that a non-lithium-containing salt is formed (e.g., via precipitation). In some embodiments, the temperature elevation is performed in a precipitation unit of a non-lithium-containing salt production unit as described above (e.g., heated concentration stream 128 may be produced by precipitation unit 126 of non-lithium-containing salt production unit 125 in FIG. 4B). In some embodiments, the precipitation unit is a vessel configured to heat liquid (e.g., by being equipped with a heater in thermal communication with the vessel). In some embodiments, the precipitation unit is configured to boil and/or evaporate the liquid (e.g., water) of the concentrated stream. In some embodiments, the concentrated stream is boiled at atmospheric pressure (e.g., between 90 and 110 kPa) while causing the concentrated stream to circulate. One example of suitable equipment for doing so is a forced circulation evaporator. Non-lithium-containing salts (e.g., NaCl, KCl) may be formed (e.g., precipitated) in the forced circulation evaporator.

In some embodiments, some (e.g., at least 5 wt %, at least 10 wt %, at least 20 wt %, at least 50 wt %, at least 80 wt %, at least 90 wt %, at least 95 wt %, at least 99 wt %, or more) or all of the non-lithium-containing salts formed during the temperature elevation of the concentrated stream are separated from the heated concentrated stream. Such a separation of solids from the heated concentrated stream may be performed using any suitable technique known in the art (e.g., filtration, centrifugation, decantation, etc.).

In some embodiments, the method of obtaining lithium (e.g., as a lithium salt) is performed such that at least a portion (e.g., at least 5 wt %, at least 10 wt %, at least 20 wt %, at least 50 wt %, at least 80 wt %, at least 90 wt %, at least 95 wt %, at least 99 wt %, or more) of the heated concentrated stream is part of the impurity-depleted concentrated stream. Incorporation of the heated concentration steam into the impurity-depleted concentrated stream may be direct or indirect.

In some embodiments, the process of removing at least some of the solubilized non-lithium cations from the concentrated stream comprises lowering a temperature of the heated concentrated stream such that an additional amount of the solid non-lithium-containing salt is formed. Such a lowering of the temperature may reduce the solubilities of the salts potentially formed by the solubilized lithium cations and non-lithium cations. It is believed that the differences in solubility of at least some lithium-containing salts and non-lithium-containing salts, and the temperature-dependences thereof, can result in solid non-lithium-containing salts being formed to a greater extent than is formed the lithium-containing salts during the temperature-lowering. In some embodiments, the temperature of the heated concentrated stream is lowered to a temperature of less than or equal to 40° C., less than or equal to 35° C., and/or as low as 30° C., or less.

Any of a variety of techniques and suitable equipment may be used to lower the temperature of the heated concentrated stream such that an additional amount of a non-lithium-containing salt is formed (e.g., via precipitation). In some embodiments, the temperature lowering is performed in a cooling unit of a non-lithium-containing salt production unit as described above (e.g., cooling unit 127 of non-lithium-containing salt production unit 125 in FIG. 4B). In some embodiments, the cooling unit is a vessel configured to cool liquid (e.g., by being equipped with a heat exchanger or refrigeration apparatus in thermal communication with the vessel). One example of a suitable equipment for lowering the temperature of the heated concentrated stream (e.g., comprising water) is a chiller. Non-lithium-containing salts (e.g., NaCl, KCl) may be formed (e.g., precipitated) in the chiller.

In some embodiments, some (e.g., at least 5 wt %, at least 10 wt %, at least 20 wt %, at least 50 wt %, at least 80 wt %, at least 90 wt %, at least 95 wt %, at least 99 wt %, or more) or all of the non-lithium-containing salts formed during the temperature lowering of the heated concentrated stream are separated from the resulting solution (e.g., stream). Such a separation of solids from the resulting solution may be performed using any suitable technique known in the art (e.g., filtration, centrifugation, decantation, etc.).

In some embodiments, the method of obtaining lithium (e.g., as a lithium salt) is performed such that at least a portion (e.g., at least 5 wt %, at least 10 wt %, at least 20 wt %, at least 50 wt %, at least 80 wt %, at least 90 wt %, at least 95 wt %, at least 99 wt %, or more) of the solution produced by the lowering of the temperature of the heated concentrated stream is part of the impurity-depleted concentrated stream. Incorporation of the resulting liquid from the lowering of the temperature of the heated concentrated stream may be direct (e.g., as illustrated by impurity-depleted concentrated stream exiting cooling unit 127 in FIG. 4D) or indirect.

In some embodiments, a method for obtaining lithium (e.g., as a lithium salt) from a liquid involves treating a solution via an electrochemical process. Such an electrochemical process may promote the at least partial replacement of counter-ions of solubilized lithium ions with different counter-ions. It has been realized that for at least some commercial/industrial applications, the lithium salts with certain counter-ions are generally more desirable or useful than those with counter-ions that may be more prevalent in feed streams. For example, in some instances, solid lithium hydroxide (LiOH) is a desirable product, while an available source of lithium ions (e.g., a salar brine) or treated product thereof is relatively rich in solubilized chloride anions but relatively lean in dissolved hydroxide ions. In some such instances, it is desirable to replace some or all of the chloride anions with hydroxide anions. It has been realized in the context of this disclosure that certain electrochemical processes may be well-suited (e.g., in terms of energy expenditure and ease of integration into lithium recovery systems) for some such lithium counter-ion replacements.

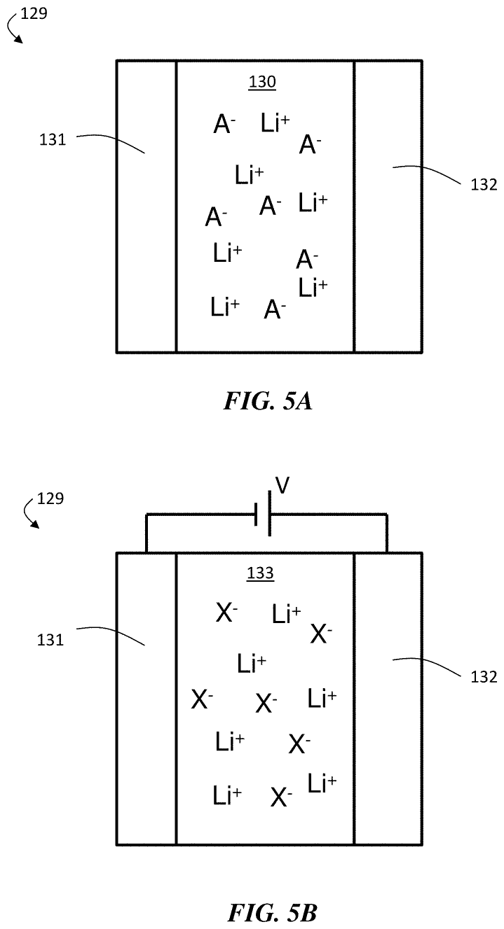

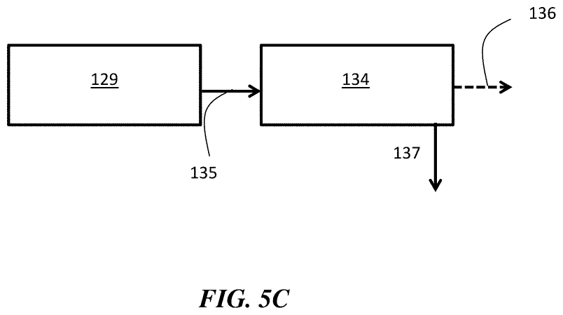

In some embodiments, a lithium recovery system comprises an electrochemical cell. FIG. 5A shows a cross-sectional schematic diagram of electrochemical cell 129, according to some embodiments. An electrochemical cell generally refers to a device capable of using electrical energy to induce chemical reactions and/or using chemical reactions to generate electrical energy. Examples of types of electrochemical cells include electrolytic cells and galvanic cells. In some embodiments, the electrochemical cell (e.g., electrochemical cell 129) is an electrolytic cell which can drive a reduction-oxidation chemical reaction via application of a voltage. In some embodiments, the electrochemical cell is a galvanic cell, in which a thermodynamically spontaneous reduction-oxidation reaction proceeds while generating electrical current across the electrodes.

In some embodiments, an initial solution (e.g., liquid solution) is associated with the electrochemical cell. For example, in some embodiments the electrochemical cell comprises a first electrode and a second electrode and at least a portion of the initial solution is in contact with at least a portion of the first electrode and/or the second electrode. The embodiment shown in FIG. 5A, for example, has initial solution 130 between first electrode 131 and second electrode 132 of electrochemical cell 129.

The initial solution may comprise a liquid, solubilized lithium cations, and solubilized first anions. For example, in FIG. 5A, initial solution 130 comprises solubilized lithium ions Li′ and solubilized first anions A⁻. The liquid may be or comprise water. For example, in some embodiments, at least 10 wt %, at least 25 wt %, at least 50 wt %, at least 75 wt %, at least 90 wt %, at least 95 wt %, at least 98 wt %, at least 99 wt %, at least 99.9 wt %, or more of the liquid is water. The first anions may be chosen from one or more of chloride, sulfate, carbonate, bicarbonate, nitrate, borate, phosphate, bromide, citrate, oxide, and hydride.

Some embodiments comprise applying a voltage to an electrochemical cell comprising the initial solution. In some such embodiments, the voltage is applied such that at least a portion (e.g., at least 5 wt %, at least 10 wt %, at least 20 wt %, at least 50 wt %, at least 80 wt %, at least 90 wt %, at least 95 wt %, at least 99 wt %, or more) of the first anions are replaced by second, different anions, thereby forming an electrochemically-treated solution comprising the liquid, solubilized lithium cations, and solubilized second anions. For example, referring to FIGS. 5A-5B, electrochemical cell 129 may initially comprise initial solution 130 (FIG. 5A), and upon application of a sufficient voltage V across first electrode 131 and second electrode 132 (FIG. 5B), at least some of first anions A⁻ are replaced by second anions X⁻, thereby forming electrochemically treated solution 133. The second anions (e.g., second anions X⁻ in FIG. 5B) may be any of a variety of different types of anions (e.g., hydroxides, halides, oxyanions), depending on a desired application. The second anions may be able to form lithium salts having more desirable properties than lithium salts comprising the first anion. For example, lithium salts comprising the second anion may have a different solubility than lithium salts comprising the first anion, which may be leveraged for downstream purification processes. In some instances, a lithium salt comprising the second anion is more commercially valuable than a lithium salt comprising the first lithium salt. For example, lithium hydroxide may be more commercially valuable than lithium chloride (e.g., for lithium ion battery applications), and so replacing at least a portion of chloride ions with hydroxide ions in a solution may be beneficial for some applications. In some embodiments, the second anions are more electronegative than the first anions. As shown in FIG. 5C, at least a portion of the electrochemically-treated solution may be transferred from the electrochemical cell (e.g., electrochemical cell 129) for further processes, such as further concentration (e.g., in a humidifier such as second humidifier 134), as described in more detail below.

In some embodiments, the electrochemically-treated solution comprises the solubilized second anions at a concentration greater than a concentration of the solubilized second anions in the initial solution. For example, in some embodiments, a ratio of a concentration of the solubilized second anions in the electrochemically-treated solution to the concentration of the solubilized second anions in the initial solution is greater than or equal to 1.1, greater than or equal to 1.2, greater than or equal to 1.5, greater than or equal to 2, greater than or equal to 5, greater than or equal to 10, greater than or equal to 100, greater than or equal to 1,000, greater than or equal to 10,000, greater than or equal to 100,000, and/or up to 1,000,000, or greater. A concentration of solubilized lithium cations may be relatively unchanged upon application of the voltage. For example, in some embodiments, a ratio of a concentration of solubilized lithium cations in the initial solution to the concentration of solubilized lithium cations in electrochemically-treated solution is less than or equal to 1.2, less than or equal to 1.1, less than or equal to 1.05, less than or equal to 1.02, less than or equal to 1, and/or as low as 0.98, as low as 0.95, as low as 0.9, or as low as 0.8.

As an illustrative example of an embodiment in which the electrochemical cell is an electrolytic cell, the initial solution may be an initial aqueous solution comprising solubilized lithium cations and solubilized chloride anions (e.g., from a brine). A voltage may be applied to drive an electrolytic reaction in which (a) the lithium ions are reduced at a first electrode to form Li⁰ (e.g., lithium metal), which may rapidly react with water to produce hydrogen gas (H₂), hydroxide anions (OH⁻), and lithium cations (Li⁺), and (b) the chloride ions are oxidized to form a product such as chlorine gas (Cl₂). The hydrogen gas and chlorine gas may be removed from the resulting electrochemically-treated solution (e.g., via bubbling), leaving the lithium cations and hydroxide anions remaining in the solution (thereby accomplishing the at least partial replacement of chloride anions with hydroxide anions).

In some embodiments, the initial solution in the electrochemical cell (e.g., initial solution 130 in FIG. 5A) comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the impurity-depleted concentrated stream described above. Such a process may promote facile anion exchange for producing desirable lithium salts derived from the feed stream (e.g., a salar brine or an extract from discarded lithium ion batteries). As an example, FIG. 6 shows an embodiment of lithium recovery system 100 in which at least a portion of impurity-depleted concentrated stream 124 is transported from non-lithium-containing salt production unit 125 to electrochemical cell 129, where application of a voltage may result in replacement of at least some of the anions (chloride anions) in impurity-depleted concentrated stream 124 with different anions (e.g., hydroxide ions) prior to further downstream processing described in more detail below. In the embodiment shown in FIG. 6, impurity-depleted concentrated stream 124 may be produced via removal of liquid from feed stream 104 via first osmotic unit 101 and humidifier 117 prior to removal of at least a portion of the solubilized non-lithium cations in non-lithium-containing salt production unit 125.

In some embodiments, liquid is removed from the electrochemically-treated solution produced by the electrochemical cell (e.g., comprising a liquid, solubilized lithium cations, and the second anions). Such liquid removal may be useful in some instances where a relatively concentrated stream of lithium cations and the second anions is desired (e.g., for obtaining a solid salt of the lithium cation and second anion). In some embodiments, at least a portion of liquid from the electrochemically-treated solution is allowed to evaporate within a humidifier to produce a humidified gas stream and a humidifier liquid outlet stream. In some embodiments, the humidifier is the same humidifier as described above with respect to the removal of liquid from the feed stream. However, in other embodiments, more than one humidifier (which can be the same or different types) can be used.

As an example, in FIGS. 5C and 6, second humidifier 134 receives some (e.g., at least 5 wt %, at least 10 wt %, at least 20 wt %, at least 50 wt %, at least 80 wt %, at least 90 wt %, at least 95 wt %, at least 99 wt %, or more) or all of the liquid output of electrochemical cell 129 via second humidifier liquid inlet stream 135. At least a portion of liquid of second humidifier liquid inlet stream 135 may be allowed to evaporate with second humidifier 134 to produce second humidified gas stream 136 (comprising at least a portion of vapor produced by the evaporation) and second humidifier liquid outlet stream 137. In some instances, some or all of the second humidified gas stream is transported to a dehumidifier, where liquid in the second humidified gas stream may be condensed to form a liquid stream (e.g., comprising substantially pure water).

In some embodiments, the humidifier liquid outlet stream (e.g., second humidifier liquid outlet stream 137) has a higher concentration of the solubilized lithium cations and the solubilized second anions compared to the electrochemically-treated solution that is transported to the humidifier. For example, a ratio of a concentration of the solubilized lithium cations in the humidifier liquid outlet stream to the concentration of solubilized lithium cations in the electrochemically-treated solution may be greater than or equal to 1.1, greater than or equal to 1.2, greater than or equal to 1.5, greater than or equal 2, greater than or equal to 5, greater than or equal to 10, greater than or equal to 20, greater than or equal to 25, greater than or equal to 50, and/or up to 100, or greater.

In some embodiments, a solid lithium salt comprising at least a portion of the lithium cations derived from the feed stream is obtained (e.g., from the impurity-depleted concentrated stream, from the electrochemically-treated solution, and/or from humidifier liquid outlet stream). For example, in some embodiments, a solid lithium salt comprising at least a portion (e.g., at least 5 wt %, at least 10 wt %, at least 20 wt %, at least 50 wt %, at least 80 wt %, at least 90 wt %, at least 95 wt %, at least 99 wt %, or more) of the lithium cations and at least a portion of the second anions (e.g., at least 5 wt %, at least 10 wt %, at least 20 wt %, at least 50 wt %, at least 80 wt %, at least 90 wt %, at least 95 wt %, at least 99 wt %, or more) from the humidifier liquid outlet stream is obtained. As one example, in some embodiments the humidifier liquid outlet stream of the humidifier that is fed some or all of the electrochemically-treated solution comprises solubilized lithium cations and solubilized hydroxide ions. Some embodiments involve obtaining solid lithium hydroxide (LiOH) from that humidifier liquid outlet stream. Referring to FIG. 6, solid lithium salt formation unit 138 may receive some or all of second humidifier liquid outlet stream 137. Solid lithium salt formation unit 138 may be any of a variety of apparatuses capable of inducing formation of solid lithium salts from solution. For example, obtaining a solid lithium salt may comprise removing liquid from the second humidifier liquid outlet stream, in some instances via heating (e.g., via boiling/evaporation). In some embodiments, the solid lithium salt formation comprises a forced circulation evaporator. In some embodiments, the solid lithium salt (e.g., LiOH) is obtained via crystallization. In some instances, the solid lithium salt is obtained by under reduced-pressure conditions (e.g., by applying a vacuum), optionally while heating. It is known that obtaining solid salts of some lithium-containing compounds such as lithium hydroxide is challenging at least because some such salts are relatively hygroscopic. It has been realized in the context of this disclosure that forming relatively concentrated solutions of solubilized cations and anions of such salts can assist with obtaining solid salts. Use of a humidifier to produce such high concentrations can be advantageous in some instances at least because a humidifier can produce sufficiently high solubilized lithium cation concentrations with relatively low energetic input and/or relatively quickly compared to typical technologies such as solar evaporation.

In some embodiments, solid lithium salt obtained can be further processed and/or packaged for commercial and/or industrial purposes. For example, lithium salt products may be obtained by filling and packing containers with the solid lithium salt. Pneumatic conveying followed by sealing using commercially-available form fill seal systems is one way to package the solid lithium salt.

In some embodiments, a pressure of any of the streams described herein can be increased via one or more additional components, such as one or more booster pumps. In some embodiments, a pressure of any of the streams described herein can be decreased via one or more additional components, such as one or more additional valves or energy recovery devices. It some embodiments, an osmotic unit described herein further comprises one or more heating, cooling, or other concentration or dilution mechanisms or devices.

The osmotic units described herein (e.g., the first osmotic unit, the second osmotic unit) can each include a single osmotic membrane or a plurality of osmotic membranes.

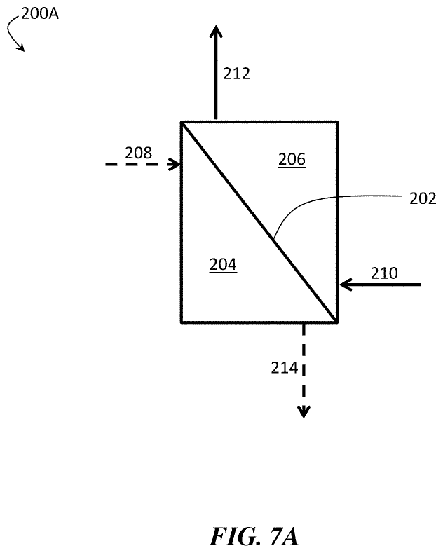

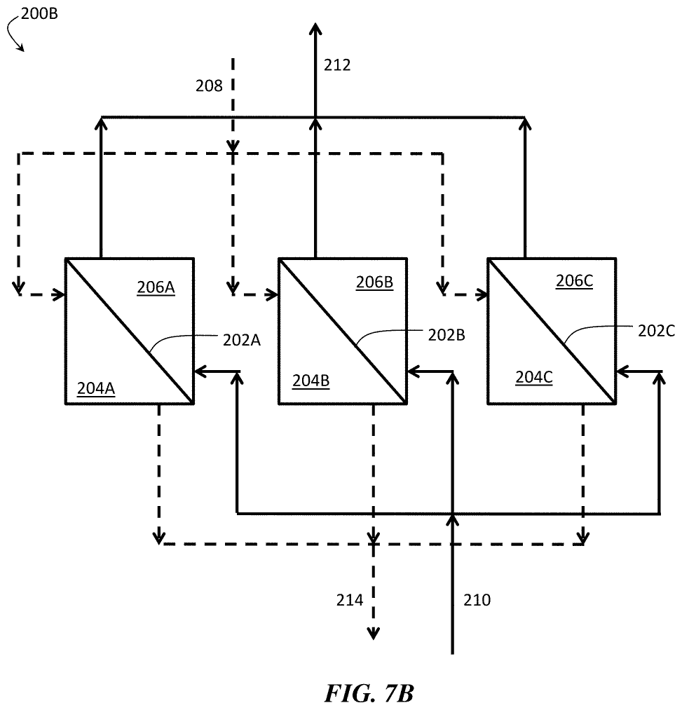

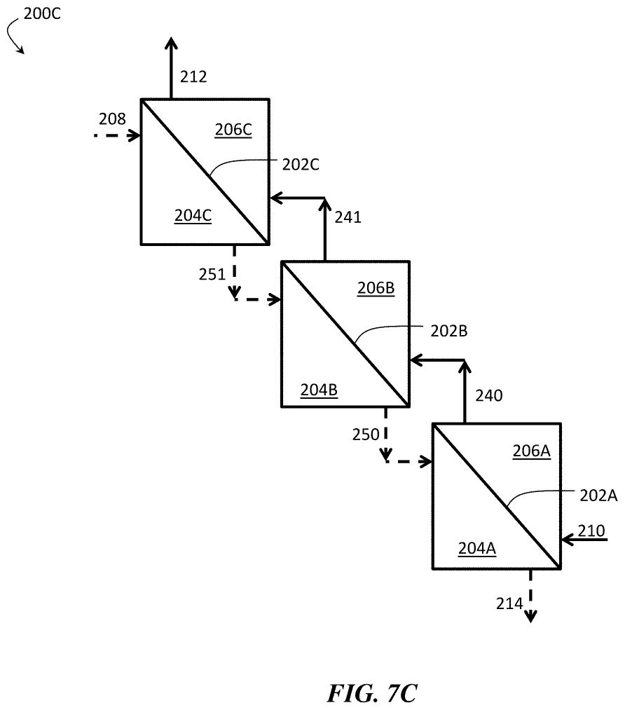

FIG. 7A is a schematic illustration of osmotic unit 200A, in which a single osmotic membrane is used to separate permeate side 204 from retentate side 206. Osmotic unit 200A can be operated by transporting retentate inlet stream 210 across retentate side 206. At least a portion of a liquid (e.g., a solvent) within retentate inlet stream 210 can be transported across osmotic membrane 202 to permeate side 204. This can result in the formation of retentate outlet stream 212, which can include a higher concentration of solute than is contained within retentate inlet stream 210, as well as permeate outlet stream 214. Optionally (e.g., when osmotic unit 200A is used as a counter-flow osmotic unit), permeate inlet stream 208 is also present. When permeate inlet stream 208 is present, it can be combined with the liquid (e.g., solvent) that has been transported to permeate side 204 from retentate side 206 to form permeate outlet stream 214. When permeate inlet stream 208 is not present (e.g., when osmotic unit 200A is used as a cross-flow osmosis unit) permeate outlet stream 214 can correspond to the liquid (e.g., solvent) of retentate inlet stream 210 that was transported from retentate side 206 to permeate side 204.

In some embodiments, an osmotic unit (e.g., the first osmotic unit, the second osmotic unit) comprises a plurality of osmotic membranes connected in parallel. One example of such an arrangement is shown in FIG. 7B. In FIG. 7B, osmotic unit 200B comprises three osmotic membranes 202A, 202B, and 202C arranged in parallel. Retentate inlet stream 210 is split into three sub-streams, with one sub-stream fed to retentate side 206A of osmotic membrane 202A, another sub-stream fed to retentate side 206B of osmotic membrane 202B, and yet another sub-stream fed to retentate side 206C of osmotic membrane 202C. Osmotic unit 200B can be operated by transporting the retentate inlet sub-streams across the retentate sides of the osmotic membranes. At least a portion of a liquid (e.g., a solvent) within retentate inlet stream 210 can be transported across each of osmotic membranes 202A, 202B, and 202C to permeate sides 204A, 204B, and 204C, respectively. This can result in the formation of three retentate outlet sub-streams, which can be combined to form retentate outlet stream 212. Retentate outlet stream 212 can include a higher concentration of solute than is contained within retentate inlet stream 210. Permeate outlet stream 214 can also be formed (from three permeate outlet sub-streams). Optionally (e.g., when osmotic unit 200B is used as a counter-flow osmotic unit), permeate inlet stream 208 is also present. When permeate inlet stream 208 is present, it can be divided into three sub-streams and transported to the permeate sides (204A, 204B, and 204C) of the three osmotic membranes (202A, 202B, and 202C) and combined with the liquid (e.g., solvent) that has been transported from the retentate sides (206A-206C) to the permeate sides (204A-204C) of the osmotic membranes (202A-202C) to form permeate outlet stream 214. When permeate inlet stream 208 is not present (e.g., when osmotic unit 200B is used as a cross-flow osmosis unit) permeate outlet stream 214 can correspond to the liquid (e.g., solvent) of retentate inlet stream 210 that was transported from retentate sides 206A-206C to permeate sides 204A-204C.

While FIG. 7B shows three osmotic membranes connected in parallel, other embodiments could include 2, 4, 5, or more osmotic membranes connected in parallel.

In some embodiments, an osmotic unit (e.g., the first osmotic unit, the second osmotic unit) comprises a plurality of osmotic membranes connected in series. One example of such an arrangement is shown in FIG. 7C. In FIG. 7C, osmotic unit 200C comprises three osmotic membranes 202A, 202B, and 202C arranged in series. In FIG. 7C, retentate inlet stream 210 is first transported to retentate side 206A of osmotic membrane 202A. At least a portion of a liquid (e.g., a solvent) within retentate inlet stream 210 can be transported across osmotic membrane 202A to permeate side 204A of osmotic membrane 202A. This can result in the formation of permeate outlet stream 214 and first intermediate retentate stream 240 that is transported to retentate side 206B of osmotic membrane 202B. At least a portion of a liquid (e.g., a solvent) within first intermediate retentate stream 240 can be transported across osmotic membrane 202B to permeate side 204B of osmotic membrane 202B. This can result in the formation of intermediate permeate outlet stream 250 and second intermediate retentate stream 241 that is transported to retentate side 206C of osmotic membrane 202C. At least a portion of a liquid (e.g., a solvent) within second intermediate retentate stream 241 can be transported across osmotic membrane 202C to permeate side 204C of osmotic membrane 202C. This can result in the formation of intermediate permeate outlet stream 251 and retentate outlet stream 212. When permeate inlet stream 208 is present, it can be transported to permeate side 204C of osmotic membrane 202C and combined with the liquid (e.g., solvent) that has been transported from retentate side 206C of osmotic membrane 202C to form intermediate permeate outlet stream 251. In some embodiments, as shown in FIG. 7C, intermediate permeate outlet stream 251 can be fed to permeate side 204B of osmotic membrane 202B and used as a sweep stream (i.e., combined with liquid that is transported through osmotic membrane 202B to form intermediate permeate outlet stream 250). In other embodiments, intermediate permeate outlet stream 251 is used directly as part (or all) of permeate outlet stream 214 (with another stream serving as the sweep stream across permeate side 204B of osmotic membrane 202B, or with osmotic membrane 202B being operated in cross-flow mode). In some embodiments, as shown in FIG. 7C, intermediate permeate outlet stream 250 can be fed to permeate side 204A of osmotic membrane 202A and used as a sweep stream (i.e., combined with liquid that is transported through osmotic membrane 202A to form permeate outlet stream 214). In other embodiments, intermediate permeate outlet stream 250 is used directly as part (or all) of permeate outlet stream 214 (with another stream serving as the sweep stream across permeate side 204A of osmotic membrane 202A, or with osmotic membrane 202A being operated in cross-flow mode).

While FIG. 7C shows three osmotic membranes connected in series, other embodiments could include 2, 4, 5, or more osmotic membranes connected in series.

In addition, in some embodiments, a given osmotic unit could include multiple osmotic membranes connected in parallel as well as multiple osmotic membranes connected in series.

In some embodiments, the first osmotic unit comprises a plurality of osmotic membranes. In some such embodiments, the plurality of osmotic membranes within the first osmotic unit are connected in series. In some such embodiments, the plurality of osmotic membranes within the first osmotic unit are connected in parallel. In certain embodiments, the first osmotic unit comprises a plurality of membranes a first portion of which are connected in series and another portion of which are connected in parallel.

In some embodiments, the second osmotic unit comprises a plurality of osmotic membranes. In some such embodiments, the plurality of osmotic membranes within the second osmotic unit are connected in series. In some such embodiments, the plurality of osmotic membranes within the second osmotic unit are connected in parallel. In certain embodiments, the second osmotic unit comprises a plurality of membranes a first portion of which are connected in series and another portion of which are connected in parallel.

The draw solutions described herein (e.g., the second osmotic unit permeate inlet stream in some embodiments) can include any of a variety of solutes and liquids. The solute(s) in the draw streams can be the same as or different from the solute(s) in the feed stream. The solvent(s) in the draw streams are generally the same as the solvent(s) in the feed stream, although variations in solvent compositions can be present at various points in the lithium recovery system.

The draw solutions described herein can generally include any component(s) suitable for imparting an appropriate osmotic pressure to perform the functions described herein. In some embodiments, the draw stream(s) are aqueous solution(s) comprising one or more solubilized species, such as one or more dissolved ions and/or one or more dissociated molecules in water. For example, in some embodiments, the draw solution(s) (e.g., the second osmotic unit permeate inlet stream in some embodiments) comprise Na⁺, Mg²⁺, Ca²⁺, Sr²⁺, Ba²⁺, Cl⁻, Al³⁺, NH₄⁺, boron, Br⁻, Cd²⁺, Cr²⁺, Cr³⁺, Co³⁺, Cu²⁺, F⁻, Pb²⁺, Lit, Mn²⁺, Mn³⁺, Hg²⁺, NO₃⁻, PO₄³⁻, HPO₄²⁻, H₂PO₄³⁻, Se²⁻, SiO₂, SO₄²⁻, Sr⁺, Fe³⁺, and/or Zn²⁺ (at varying concentrations of each species). The draw stream(s) may have P-alkalinity or M-alkalinity in any of a variety of suitable ranges. In some embodiments, the draw solution(s) (e.g., the second osmotic unit permeate inlet stream in some embodiments) comprises at least one solubilized monovalent cation, such as Na⁺ and/or K⁺. In certain embodiments, the draw solution(s) (e.g., the second osmotic unit permeate inlet stream in some embodiments) comprises at least one monovalent anion, such as Cl⁻ and/or Br⁻. Cations and/or anions having other valencies may also be present in the draw solution(s) (e.g., the second osmotic unit permeate inlet stream in some embodiments). Other species could also be used in the draw solutions. For example, in some embodiments, the draw solution(s) (e.g., the second osmotic unit permeate inlet stream in some embodiments) can be an aqueous stream comprising a solubilized non-ionic species, such as ammonia (NH₃).

Those of ordinary skill in the art, given the insight provided by the present disclosure, would be capable of selecting appropriate components for use in the various draw streams described herein.

The draw streams may be prepared, according to certain embodiments, by suspending and/or dissolving one or more species in a liquid acting as a solvent (such as an aqueous solvent) to solubilize the species in the solvent. For example, in some embodiments, one or more draw inlet streams can be made by dissolving one or more solid salts in an aqueous solvent. Non-limiting examples of salts that may be dissolved in water include NaCl, LiCl, CaCl₂, MgCl₂, NaOH, other inorganic salts, and the like. In some embodiments, the draw stream can be prepared by mixing ammonia with water. In certain embodiments, the draw stream can be prepared by dissolving one or more ammonia salts (e.g., ammonium bicarbonate, ammonium carbonate, and/or ammonium carbamate) in water. In some embodiments, the draw stream can be prepared by dissolving ammonia and carbon dioxide gasses in water.

According to certain embodiments, the streams on either side of an osmotic membrane(s) within the osmotic unit can be operated in counter-current configuration. Operation of the osmotic system in this manner can, according to certain but not necessarily all embodiments, allow one to more easily ensure that the transmembrane net driving force is spatially uniform across the facial area of the osmotic membrane, for example, as described in International Patent Publication No. WO 2017/019944, filed Jul. 29, 2016 as International Patent Application No. PCT/US2016/044663, and entitled “Osmotic Desalination Methods and Associated Systems,” which is incorporated herein by reference in its entirety. It should be understood that two streams do not have to be transported in perfectly parallel and opposite directions to be considered to be in counter-current configuration, and in some embodiments, the primary flow directions of two streams that are in a counter-current flow configuration can form an angle of up to 10° (or, in some cases, up to 5°, up to 2°, or up to 1°). In some embodiments, the second osmotic unit is operated in a counter-current configuration.

Those of ordinary skill in the art are familiar with osmotic membranes. The membrane medium can comprise, for example, a metal, a ceramic, a polymer (e.g., polyamides, polyethylenes, polyesters, poly(tetrafluoroethylene), polysulfones, polycarbonates, polypropylenes, poly(acrylates)), and/or composites or other combinations of these. Osmotic membranes generally allow for the selective transport of solvent (e.g., water) through the membrane, where solvent is capable of being transmitted through the membrane while solute (e.g., solubilized species such as solubilized ions) are inhibited from being transported through the membrane. Examples of commercially available osmotic membranes that can be used in association with certain of the embodiments described herein include, but are not limited to, those commercially available from Dow Water and Process Solutions (e.g., FilmTec™ membranes), Hydranautics, GE Osmonics, Suez, LG, Toyobo, and Toray Membrane, among others known to those of ordinary skill in the art.

According to some embodiments, the humidifier described above is a bubble column humidifier (e.g., a humidifier in which the evaporation process occurs through direct contact between an aqueous stream and bubbles of a carrier gas). As discussed in further detail below, a bubble column humidifier may be associated with certain advantages. In some embodiments, the humidifier is a packed bed humidifier (e.g., a humidifier comprising packing material). The packing material may, in some cases, facilitate turbulent gas flow and/or enhance contact between an aqueous stream flowing in a first direction through the packing material and a carrier gas flowing in a second, substantially opposite direction. A non-limiting example of suitable packing material is polyvinyl chloride (PVC) packing material. In certain cases, the humidifier is a spray tower (e.g., a humidifier configured to spray droplets of an aqueous stream). For example, a nozzle or other spraying device may be positioned at the top of the humidifier such that the aqueous stream is sprayed downward towards the bottom of the humidifier. The use of a spraying device may advantageously increase the degree of contact between an aqueous stream fed to the humidifier and a carrier gas into which water from the aqueous stream is transported. The humidifier may, in some embodiments, be a packed bed humidifier and a spray tower (e.g., the spray tower may comprise packing material). In some embodiments, the humidifier is a wetted wall tower (e.g., a humidifier in which the evaporation process occurs through direct contact between a fluid film or laminar layer and a carrier gas).

In some embodiments, the humidifier is configured to be a counter-flow device. For example, in certain cases, the humidifier is configured such that a humidifier liquid inlet is positioned at a first end (e.g., a top end) of the humidifier and a humidifier gas inlet is positioned at a second, opposite end (e.g., a bottom end) of the humidifier. Such a configuration may facilitate the flow of a liquid stream in a first direction (e.g., downwards) through the humidifier and the flow of a gas stream in a second, substantially opposite direction (e.g., upwards) through the humidifier, which may advantageously result in high thermal efficiency.

In some embodiments, in which a humidification-dehumidification (HDH) apparatus comprising a humidifier and a dehumidifier as described above is used, the dehumidifier of the HDH apparatus may have any configuration that allows for the transfer of water from a humidified gas stream produced by a humidifier to a substantially pure water stream through a condensation process. In some embodiments, the dehumidifier comprises a gas inlet configured to receive the humidified gas stream from the humidifier and/or a liquid inlet configured to receive a substantially pure water stream (e.g., from a source of substantially pure water). The dehumidifier may further comprise a dehumidifier liquid outlet and/or a dehumidifier gas outlet.

In certain embodiments, the dehumidifier is a bubble column dehumidifier (e.g., a dehumidifier in which the condensation process occurs through direct contact between a substantially pure water stream and bubbles of a humidified gas). In certain cases, the dehumidifier is a surface condenser (e.g., a dehumidifier in which the condensation process occurs through direct contact between a humidified gas and a cooled surface). Non-limiting examples of suitable surface condensers include a cooling tube condenser and a plate condenser.

In some embodiments, the dehumidifier is configured to be a counter-flow device. For example, in certain cases, the dehumidifier is configured such that a dehumidifier liquid inlet is positioned at a first end (e.g., a top end) of the dehumidifier and a dehumidifier gas inlet is positioned at a second, opposite end (e.g., a bottom end) of the dehumidifier. Such a configuration may facilitate the flow of a liquid stream in a first direction (e.g., downwards) through the dehumidifier and the flow of a gas stream in a second, substantially opposite direction (e.g., upwards) through the dehumidifier, which may advantageously result in high thermal efficiency.

According to some embodiments, the humidifier is a bubble column humidifier, and/or the dehumidifier is a bubble column dehumidifier. In some cases, bubble column humidifiers and bubble column dehumidifiers may be associated with certain advantages. For example, bubble column humidifiers and dehumidifiers may exhibit higher thermodynamic effectiveness than certain other types of humidifiers and dehumidifiers. Without wishing to be bound by a particular theory, the increased thermodynamic effectiveness may be at least partially attributed to the use of gas bubbles for heat and mass transfer in bubble column humidifiers and dehumidifiers, since gas bubbles may have more surface area available for heat and mass transfer than many other types of surfaces (e.g., metallic tubes, liquid films, packing material). In addition, bubble column humidifiers and dehumidifiers may have certain features that further increase thermodynamic effectiveness, including, but not limited to, relatively low liquid level height, relatively high aspect ratio liquid flow paths, and multi-staged designs.

Suitable bubble column condensers that may be used as the dehumidifier and/or suitable bubble column humidifiers that may be used as the humidifier in certain systems and methods described herein include those described in U.S. Pat. No. 8,523,985, by Govindan et al., issued Sep. 3, 2013, and entitled “Bubble-Column Vapor Mixture Condenser”; U.S. Pat. No. 8,778,065, by Govindan et al., issued Jul. 15, 2014, and entitled “Humidification-Dehumidification System Including a Bubble-Column Vapor Mixture Condenser”; U.S. Patent Publication No. 2013/0074694, by Govindan et al., filed Sep. 23, 2011, and entitled “Bubble-Column Vapor Mixture Condenser”; U.S. Patent Publication No. 2014/0367871, by Govindan et al., filed Jun. 12, 2013, and entitled “Multi-Stage Bubble Column Humidifier”; U.S. Patent Publication No. 2015/0083577, filed on Sep. 23, 2014, and entitled “Desalination Systems and Associated Methods”; U.S. Patent Publication No. 2015/0129410, filed on Sep. 12, 2014, and entitled “Systems Including a Condensing Apparatus Such as a Bubble Column Condenser”; U.S. patent application Ser. No. 14/718,483, by Govindan et al., filed May 21, 2015, and entitled “Systems Including an Apparatus Comprising both a Humidification Region and a Dehumidification Region”; U.S. patent application Ser. No. 14/718,510, by Govindan et al., filed May 21, 2015, and entitled “Systems Including an Apparatus Comprising both a Humidification Region and a Dehumidification Region with Heat Recovery and/or Intermediate Injection”; U.S. patent application Ser. No. 14/719,239, by Govindan et al., filed May 21, 2015, and entitled “Transiently-Operated Desalination Systems and Associated Methods”; U.S. patent application Ser. No. 14/719,189, by Govindan et al., filed May 21, 2015, and entitled “Transiently-Operated Desalination Systems with Heat Recovery and Associated Methods”; U.S. patent application Ser. No. 14/719,295, by St. John et al., filed May 21, 2015, and entitled “Methods and Systems for Producing Treated Brines”; and U.S. patent application Ser. No. 14/719,299, by St. John et al., and entitled “Methods and Systems for Producing Treated Brines for Desalination,” each of which is incorporated herein by reference in its entirety for all purposes.

In some embodiments in which substantially pure water is formed, the substantially pure water stream has a relatively low total solubilized ion concentration (e.g., concentration of all solubilized ions present in the water stream). In some cases, the total solubilized ion concentration of the substantially pure water stream is about 500 mg/L or less, about 200 mg/L or less, about 100 mg/L or less, about 50 mg/L or less, about 20 mg/L or less, about 10 mg/L or less, about 5 mg/L or less, about 2 mg/L or less, about 1 mg/L or less, about 0.5 mg/L or less, about 0.2 mg/L or less, about 0.1 mg/L or less, about 0.05 mg/L or less, about 0.02 mg/L or less, or about 0.01 mg/L or less. According to some embodiments, the total solubilized ion concentration of the substantially pure water stream is substantially zero (e.g., not detectable). In certain cases, the total solubilized ion concentration of the substantially pure water stream is in the range of about 0 mg/L to about 500 mg/L, about 0 mg/L to about 200 mg/L, about 0 mg/L to about 100 mg/L, about 0 mg/L to about 50 mg/L, about 0 mg/L to about 20 mg/L, about 0 mg/L to about 10 mg/L, about 0 mg/L to about 5 mg/L, about 0 mg/L to about 2 mg/L, about 0 mg/L to about 1 mg/L, about 0 mg/L to about 0.5 mg/L, about 0 mg/L to about 0.1 mg/L, about 0 mg/L to about 0.05 mg/L, about 0 mg/L to about 0.02 mg/L, or about 0 mg/L to about 0.01 mg/L.

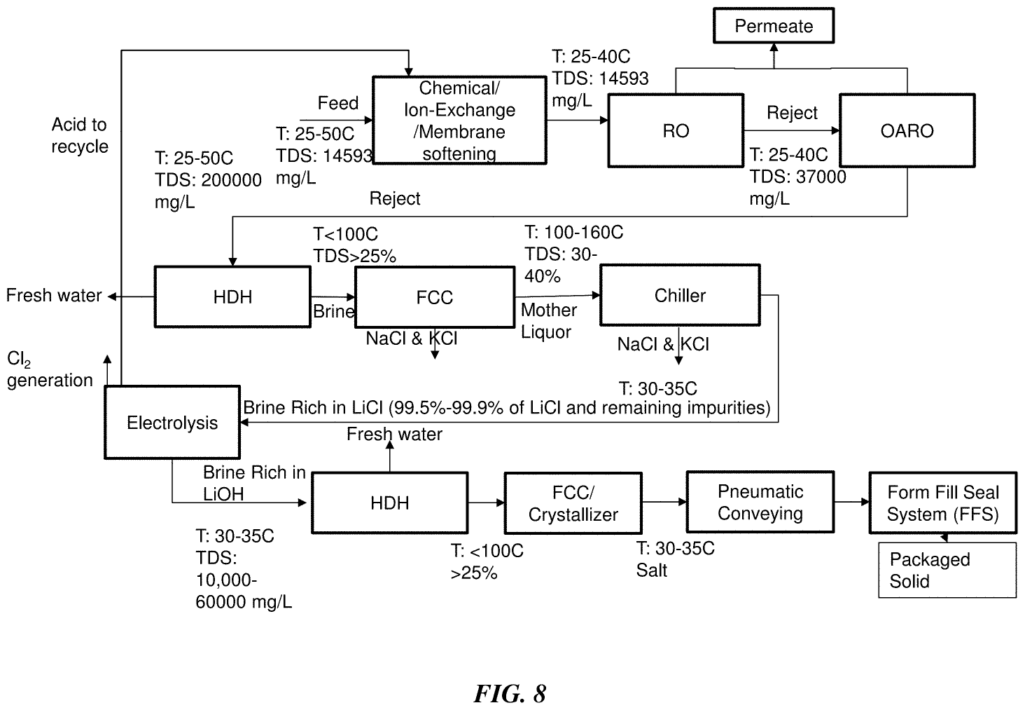

In one example, lithium hydroxide is obtained from a brine (e.g., a salar brine) rich in solubilized lithium cations and solubilized chloride anions using methods and systems described in this disclosure. FIG. 8 shows a schematic process diagram for the solid lithium hydroxide recovery. A feed stream first undergoes a softening process, in which scale-forming ions (e.g., multivalent cations, silica) are removed using one or more of chemical treatment (e.g., with lime, dolomite, activated alumina, iron chloride, sodium hypochlorite, and/or polymers (e.g., polyelectrolytes) while in some instances maintaining a pH from 8 to 8.5), ion exchange or membrane softening (e.g., nanofiltration or electrodialysis). Prior to the softening, the feed stream may be at a temperature in the range of 25 to 50° C., a pH in the range of 2-14, and have a total dissolved solids concentration of 14593 mg/L (including a lithium cation concentration of from 10 mg/L to 680 mg/L). Following the softening, the feed stream has a temperature in the range of from 25 to 40° C. (e.g., 25 to 36° C.), a pH of approximately 5.5, and a total dissolved solids concentration (TDS) of 14593 mg/L. The feed stream is then fed to the retentate side of a first osmotic unit (“RO”) at a flow rate of approximately 2.5 m³/hr and a hydraulic pressure is applied to perform a reverse osmosis process. The reject of the first osmotic unit is then fed to the retentate side of a second osmotic unit (an osmotically assisted reverse osmosis unit, “OARO”) at a flow rate of approximately 1.3 m³/hr while a draw stream is fed to the permeate side of OARO during a reverse osmosis process. The reject fed to OARO has a temperature in the range of from 25 to 40° C. (e.g., 25 to 36° C.), and a total dissolved solids concentration of 37,000 mg/L. The permeate from both RO (having a total dissolved solids concentration of less than 500 mg/L) and OARO can discharged from the system (as shown in FIG. 8), though in some instances the permeate from the OARO can be recycled back to the retentate inlet stream of the RO or the OARO. The reject from OARO has a temperature in the range of from 25 to 50° C. (e.g., 25 to 40° C. or 25 to 36° C.) and a total dissolved solids concentration of 200,000 mg/L. The reject from the OARO is fed to an HDH apparatus (“HDH”) comprising a packed bed humidifier and a multi-stage bubble column dehumidifier. The HDH produces fresh water (which can be discharged from the system) and a brine having a temperature less than 100° C. and a total dissolved solids concentration of 250,000 mg/L. The brine from the HDH is fed to a forced circulation evaporator (FCC), where non-lithium salts separation takes place. In FCC, the brine is heated under atmospheric pressure until it starts to boil, and continued boiling at temperatures reaching from 100° C. to 160° C. while circulating the brine results in the precipitation of mixtures of potassium and sodium chloride. The resulting mother liquor from FCC, which has a total dissolved solids concentration of 300,000-400,000 mg/L, is fed to a chiller (e.g., part of a crystallizer). In the chiller, the temperature is reduced to 30-35° C. and further precipitation of NaCl and KCl occurs while maintaining a substantially same amount of solubilized lithium ions in the mother liquor. The precipitates are separated from the mother liquor (e.g., by decantation). Additional lithium cations may be recovered by washing the precipitates with a small quantity of feed water and sending that quantity of feed water back to the feed stream. The precipitates may be sent for further processing, such as via a centrifuge/agitated thin film dryer crystallizer to obtain solid NaCl and KCl having low moisture. The lithium-rich mother liquor/supernatant from the FCC/chiller is fed to an electrolysis unit. In the electrolysis unit, Cl₂ and acid is generated. The Cl₂ is discharged from the system, and the acid may be recycled back for use in the softening process for the feed stream. The electrolysis unit produces a brine rich in LiOH, at a temperature in the range of from 30° C. to 35° C. and a total dissolved solids concentration of 10,000-60,000 mg/L. The brine rich in LiOH is transferred from the electrolysis unit to a second HDH unit, where it is further concentrated in a humidifier (while the dehumidifier produces fresh water). The further concentrated brine rich in LiOH, which in some instances may have a total dissolved salts concentration of greater than 250,000 mg/L, is transferred to another FCC/crystallizer, where solid LiOH salt is produced. The solid LiOH salt may then undergo pneumatic conveying and packaging in a form fill seal system.

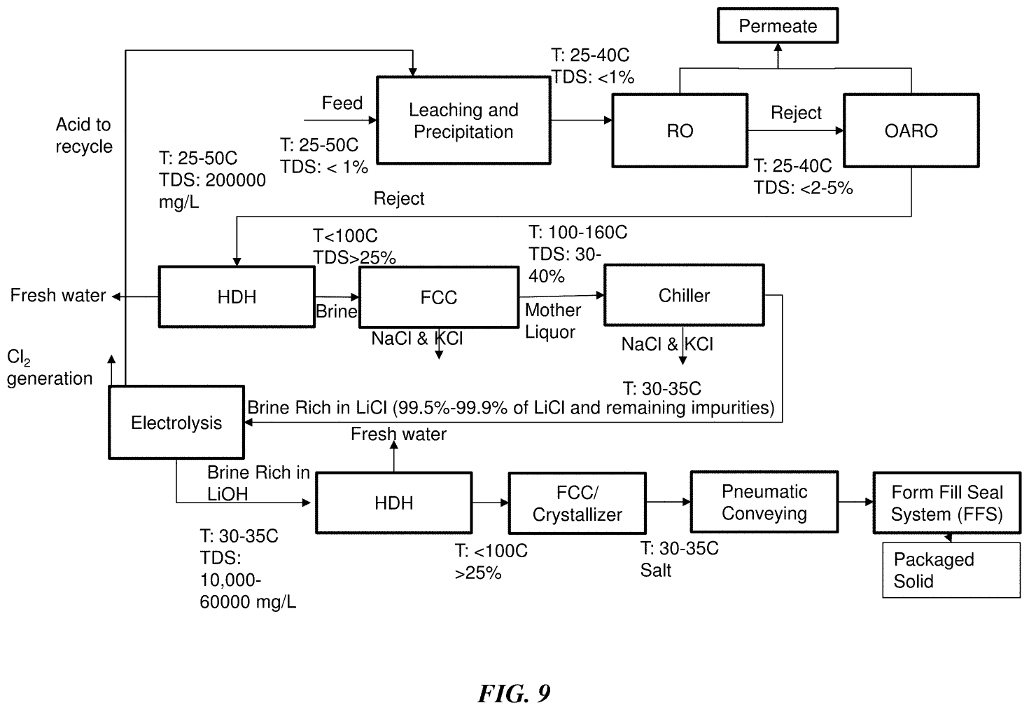

In another example, solid lithium hydroxide is obtained from a solution rich in solubilized lithium cations and solubilized sulfate and carbonate anions using methods and systems described in this disclosure. FIG. 9 shows a schematic process diagram for the solid lithium hydroxide recovery. A feed stream first undergoes a leaching and precipitation process, during which the sulfate and carbonate anions are replaced via chemically-induced precipitation and/or leaching, and chloride anions remain and/or are added. Prior to the leaching and precipitation, the feed stream may be at a temperature in the range of 25 to 50° C., a pH in the range of 2-14, and have a total dissolved solids concentration of <1%. Following the leaching and precipitation, the feed stream has a temperature in the range of from 25 to 40° C. (e.g., 25 to 36° C.), a pH of approximately 5.5, and a total dissolved solids concentration of <1%. The feed stream is then fed to the retentate side of a first osmotic unit (“RO”) at a flow rate of approximately 2.5 m³/hr and a hydraulic pressure is applied to perform a reverse osmosis process. The reject of the first osmotic unit is then fed to the retentate side of a second osmotic unit (an osmotically assisted reverse osmosis unit, “OARO”) at a flow rate of approximately 1.3 m³/hr while a draw stream is fed to the permeate side of OARO during a reverse osmosis process. The reject fed to OARO has a temperature in the range of from 25 to 40° C. (e.g., 25 to 36° C.), and a total dissolved solids concentration of <2-5%. The permeate from both RO (having a total dissolved solids concentration of less than 500 mg/L) and OARO can discharged from the system (as shown in FIG. 9), though in some instances the permeate from the OARO can be recycled back to the retentate inlet stream of the RO or the OARO. The reject from OARO has a temperature in the range of from 25 to 50° C. (e.g., 25 to 40° C. or 25 to 36° C.) and a total dissolved solids concentration of 200,000 mg/L. The remainder of the process shown in this example, as shown in FIG. 9, is the same as that shown in FIG. 8 and described above.

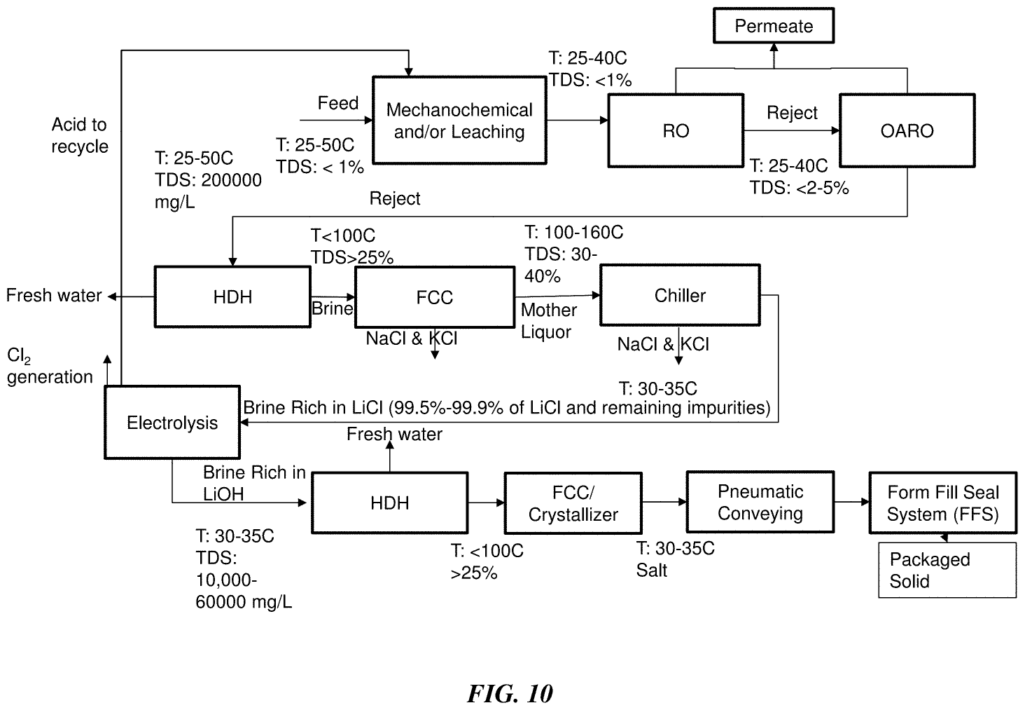

In another example, solid lithium hydroxide is obtained from a solution derived from lithium ion batteries (e.g., discarded/spent lithium ion batteries) using methods and systems described in this disclosure. FIG. 10 shows a schematic process diagram for the solid lithium hydroxide recovery. A feed stream supplied directly or indirectly from one or more lithium ion batteries first undergoes a mechanochemical and/or leaching process (e.g., via addition of hydrochloric acid, sulfuric acid, nitric acid, acetic acid, and/or citric acid), and chloride anions remain and/or are added. Prior to the mechanochemical and/or leaching processes, the feed stream may be at a temperature in the range of 25 to 50° C. (e.g., 25 to 40° C. or 25 to 36° C.), a pH in the range of 2-14, and have a total dissolved solids concentration of <1%. Following the mechanochemical and/or leaching processes, the feed stream has a temperature in the range of from 25 to 40° C. (e.g., 25 to 36° C.), a pH of approximately 5.5, and a total dissolved solids concentration of <1%. The feed stream is then fed to the retentate side of a first osmotic unit (“RO”) at a flow rate of approximately 2.5 m³/hr and a hydraulic pressure is applied to perform a reverse osmosis process. The reject of the first osmotic unit is then fed to the retentate side of a second osmotic unit (an osmotically assisted reverse osmosis unit, “OARO”) at a flow rate of approximately 1.3 m³/hr while a draw stream is fed to the permeate side of OARO during a reverse osmosis process. The reject fed to OARO has a temperature in the range of from 25 to 40° C. (e.g., 25 to 36° C.), and a total dissolved solids concentration of <2-5%. The permeate from both RO (having a total dissolved solids concentration of less than 500 mg/L) and OARO can discharged from the system (as shown in FIG. 10), though in some instances the permeate from the OARO can be recycled back to the retentate inlet stream of the RO or the OARO. The reject from OARO has a temperature in the range of from 25 to 50° C. (e.g., 25 to 40° C. or 25 to 36° C.) and a total dissolved solids concentration of 200,000 mg/L. The remainder of the process shown in this example, as shown in FIG. 10, is the same as that shown in FIG. 8 and described above.

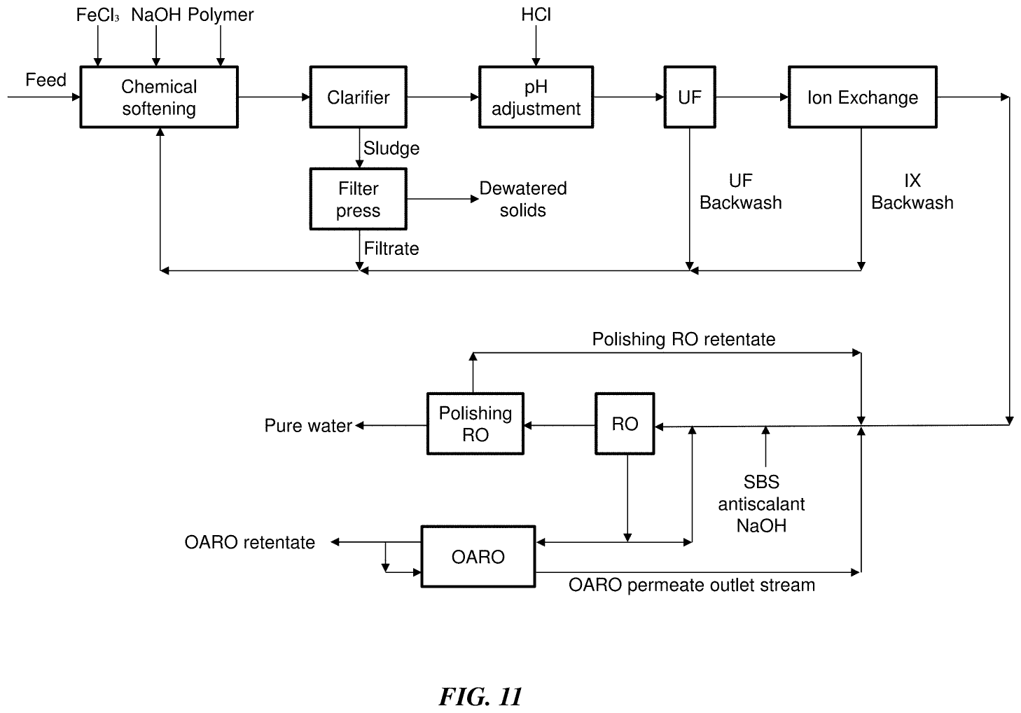

In another example, a lithium-containing stream (e.g., comprising solubilized lithium cations in an amount of at least 10 mg/L) is concentrated using methods described in this disclosure. FIG. 11 shows a schematic process diagram for such a lithium ion concentration process. A feed stream first undergoes a softening process in which scale-forming ions (e.g., multivalent cations, silica) are removed using chemical treatment, clarification, multi-media filtration, and ion exchange. Ferric chloride (FeCl₃), sodium hydroxide (NaOH) and a polymer flocculant are added to the feed stream in a series of continuously stirred-tank reactors (“Chemical Softening” in FIG. 11) to cause precipitation of hardness and facilitate flocculation. Flocculated precipitate (“sludge” in FIG. 11) is settled from the feed stream in a clarifier, and a clarified supernatant stream is removed. The clarified supernatant is pH adjusted with the addition of hydrochloric acid (HCl), ultrafiltered (“UF” in FIG. 11), and introduced to an ion exchange column containing a strong acid cation resin for additional hardness removal to produce a softened feed stream. Flocculated precipitate settled from the supernatant in the clarifier (“sludge”) is dewatered in a filter press, and the resulting dewatered solids are discharged from the system. Backwash waste from the ultrafilters (“UF Backwash” in FIG. 11) and ion exchange regeneration (“IX” Backwash” in FIG. 11) are combined with filter press filtrate and recycled back to the chemical softening process where they are combined with the feed stream. The softened feed stream is treated with sodium bisulfate (“SBS”), antiscalant, and sodium hydroxide, pumped through a cartridge filter, combined with a portion of an RO reject stream to form an RO inlet stream, pressurized to 7.5 MPa, and introduced to a the retentate side of a first osmotic unit (“RO” in FIG. 11). The hydraulic pressure on the retentate side of the RO membrane overcomes the osmotic pressure of the RO inlet stream, causing an RO permeate stream to diffuse through the RO membrane leaving behind the RO retentate stream. The RO permeate stream is pressurized again and introduced to the retentate side of a second osmotic unit (“polishing RO” in FIG. 11). The hydraulic pressure on the retentate side of the polishing RO overcomes the osmotic pressure of the RO permeate stream, causing a polishing RO permeate stream, comprised of substantially pure water, to diffuse through the polishing RO membrane, leaving behind a polishing RO retentate stream. The polishing RO permeate stream is delivered to a customer as a final product, and the polishing RO retentate stream is combined with the softened feed stream. A portion of the RO retentate stream is combined with the softened feed stream to form the RO inlet stream, and the remainder is introduced to the retentate side of a third osmotic membrane unit (“OARO” in FIG. 11) as an OARO retentate inlet stream. The OARO system contains multiple (e.g., at least 2, at least 5, at least 10, or more) membranes arranged with their retentate and permeate sides connected in series. The hydraulic pressure difference across each of the OARO membranes overcomes the osmotic pressure difference, and substantially pure water diffuses across the membranes from the OARO retentate stream and combines on the permeate side with an OARO permeate inlet stream to form an OARO permeate outlet stream, leaving behind an OARO retentate outlet stream. The OARO retentate outlet stream is depressurized, and a first portion of the stream is discharged from the system. A second portion of the depressurized OARO retentate outlet stream is to the permeate side of the OARO membrane unit as the OARO permeate inlet stream (e.g., in a counter-current configuration).

U.S. Provisional Patent Application No. 63/164,649, filed Mar. 23, 2021, and entitled “Lithium Recovery from Liquid Streams,” is incorporated herein by reference in its entirety for all purposes.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrase “at least a portion” means some or all. “At least a portion” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. (canceled)

2. A method for obtaining a solid lithium salt from a liquid, comprising:
applying a voltage to an electrochemical cell comprising an initial solution comprising a liquid, solubilized lithium cations, and solubilized first anions, such that at least a portion of the first anions are replaced by second, different anions, thereby forming an electrochemically-treated solution comprising the liquid, solubilized lithium cations, and solubilized second anions at a concentration greater than a concentration of the solubilized second anions in the initial solution;
allowing at least a portion of liquid from the electrochemically-treated solution to evaporate within a humidifier to produce a humidified gas stream and a humidifier liquid outlet stream having a higher concentration of the solubilized lithium cations and the solubilized second anions compared to the electrochemically-treated solution; and
obtaining solid lithium salt comprising at least a portion of the lithium cations and at least a portion of the second anions from the humidifier liquid outlet stream.

3-24. (canceled)

25. The method of claim 2, wherein the first anions are chloride ions.

26. The method of claim 25, wherein the second anions are hydroxide ions.

27. The method of claim 2, further comprising allowing at least a portion of liquid from the electrochemically-treated solution to evaporate within a humidifier to produce a second humidified gas stream and a second humidifier liquid outlet stream having a higher concentration of solubilized lithium cations and solubilized second anions compared a concentration of solubilized lithium cations and solubilized second anions in the electrochemically-treated solution.

28. The method of claim 27, further comprising obtaining a solid lithium salt comprising at least a portion of the lithium cations and at least a portion of the second anions from the second humidifier liquid outlet stream.

29. A method, comprising:
removing at least a portion of liquid from a feed stream comprising a liquid and a solubilized lithium cation to form a concentrated stream having a higher concentration of the solubilized lithium cation compared to the feed stream, wherein the removing comprises:
transporting a first osmotic unit retentate inlet stream comprising at least a portion of the feed stream to a retentate side of a first osmotic unit such that:
a first osmotic unit retentate outlet stream exits the retentate side of the first osmotic unit, the first osmotic unit retentate outlet stream having a concentration of solubilized lithium cations that is greater than a concentration of solubilized lithium cations in the first osmotic unit retentate inlet stream, and
at least a portion of liquid from the first osmotic unit retentate inlet stream is transported from the retentate side of the first osmotic unit, through an osmotic membrane of the first osmotic unit, to a permeate side of the first osmotic unit; and
transporting a second osmotic unit retentate inlet stream comprising at least a portion of the first osmotic unit retentate outlet stream to a retentate side of a second osmotic unit such that:
a second osmotic unit retentate outlet stream exits the retentate side of the second osmotic unit, the second osmotic unit retentate outlet stream having a higher concentration of solubilized lithium cations than a concentration of solubilized lithium cations of the second osmotic unit retentate inlet stream, such that at least a portion of the second osmotic unit retentate outlet stream is part of the concentrated stream, and
at least a portion of liquid from the second osmotic unit retentate inlet stream is transported from the retentate side of the second osmotic unit, through an osmotic membrane of the second osmotic unit, to a permeate side of the second osmotic unit where the portion of the liquid is combined with a second osmotic unit permeate inlet stream to form a second osmotic unit permeate outlet stream that is transported out of the permeate side of the second osmotic unit;
wherein:
a concentration of solubilized lithium cations in the feed stream is greater than or equal to 10 mg/L, and
a ratio of a concentration of solubilized lithium cations in the concentrated stream to the concentration of solubilized lithium cations in the feed stream is greater than or equal to 4.

30. The method of claim 29, wherein the first osmotic unit retentate inlet stream comprises a portion of the first osmotic unit retentate outlet stream.

31. The method of claim 29, wherein the first osmotic unit retentate inlet stream comprises at least a portion of the second osmotic unit permeate outlet stream.

32. The method of claim 29, wherein the second osmotic unit permeate inlet stream comprises a portion of the second osmotic unit retentate outlet stream.

33. The method of claim 29, wherein the feed stream further comprises a solubilized non-lithium cation, and wherein the method further comprising removing at least some of the solubilized non-lithium cations from the concentrated stream to form an impurity-depleted concentrated steam having an atomic ratio of solubilized lithium cations to solubilized non-lithium cations that is larger than an atomic ratio of solubilized lithium cations to solubilized non-lithium cations in the concentrated stream.

34. The method of claim 29, wherein the removing the at least a portion of liquid from the feed stream comprises transporting a humidifier liquid inlet stream comprising at least a portion of the second osmotic unit retentate outlet stream to a humidifier and allowing at least a portion of liquid of the humidifier liquid inlet stream to evaporate within the humidifier to produce a humidified gas stream and a humidifier liquid outlet stream having a higher concentration of the solubilized lithium cation compared to the humidifier liquid inlet stream, such that at least a portion of the humidifier liquid outlet stream is part of the concentrated stream.

35. The method of claim 34, further comprising condensing at least a portion of the liquid within the humidified gas within a dehumidifier to produce a condensed liquid stream.

36. The method of claim 35, wherein the dehumidifier is a bubble column dehumidifier.

37. The method of claim 34, wherein the humidifier is a packed bed humidifier or a bubble column humidifier.

38. The method of claim 29, wherein the feed stream comprises an anion chosen from one or more of chloride, sulfate, carbonate, bicarbonate, nitrate, borate, phosphate, bromide, citrate, oxide, and hydride.

39. The method claim 33, wherein the non-lithium cation is chosen from one or more of sodium cation, potassium cation, magnesium cation, and calcium cation.

40. The method of claim 33, wherein the removing at least some of the solubilized non-lithium cations from the concentrated stream results in the impurity-depleted concentrated stream having a lower concentration of the solubilized non-lithium cation compared to the concentrated stream.

41. The method of claim 33, wherein the removing at least some of the solubilized non-lithium cations from the concentrated stream results in a ratio of a concentration of solubilized lithium cations to a total concentration of all solubilized non-lithium cations in the impurity-depleted concentrated stream that is greater than a ratio of a concentration of solubilized lithium cations to a total concentration of all solubilized non-lithium cations in the concentrated stream by a factor of at least 1.1.

42. The method of claim 33, wherein the removing at least some of the solubilized non-lithium cations from the concentrated stream comprises elevating a temperature of the concentrated stream to form a heated concentrated stream such that an amount of a solid non-lithium-containing salt comprising at least a portion of the non-lithium cations is formed.

43. The method of claim 42, wherein the non-lithium-containing salt comprises a cation chosen from one or more of sodium and potassium and an anion chosen from one or more of chloride, sulfate, carbonate, bicarbonate, nitrate, borate, phosphate, bromide, citrate, oxide, and hydride.

44. The method of claim 42, wherein the removing at least some of the solubilized non-lithium cations from the concentrated stream further comprises lowering a temperature of the heated concentrated stream such that an additional amount of the solid non-lithium-containing salt is formed.

45. The method of claim 33, wherein the impurity-depleted concentrated stream comprises solubilized first anions, and the method further comprises applying a voltage to an electrochemical cell comprising at least a portion of the impurity-depleted concentrated stream such that at least a portion of the first anions are replaced by second, different anions, thereby forming an electrochemically-treated solution comprising the liquid, solubilized lithium cations, and solubilized second anions at a concentration greater than a concentration of the solubilized second anions in the impurity-depleted concentrated stream.

46. The method of claim 45, wherein the first anions are chloride ions.

47. The method of claim 46, wherein the second anions are hydroxide ions.

48. The method of claim 45, wherein the second anions are hydroxide ions.

49. The method of claim 45, further comprising allowing at least a portion of liquid from the electrochemically-treated solution to evaporate within a humidifier to produce a second humidified gas stream and a second humidifier liquid outlet stream having a higher concentration of solubilized lithium cations and solubilized second anions compared a concentration of solubilized lithium cations and solubilized second anions in the electrochemically-treated solution.

50. The method of any one of claim 49, further comprising obtaining a solid lithium salt comprising at least a portion of the lithium cations and at least a portion of the second anions from the second humidifier liquid outlet stream.

51. The method of claim 2, wherein the second anions are hydroxide ions.

52. The method of claim 2, wherein the initial solution comprises at least a portion of a concentrated stream produced by a method comprising:
removing at least a portion of liquid from a feed stream comprising a liquid and solubilized lithium cations to form the concentrated stream, the concentrated stream having a higher concentration of the solubilized lithium cation compared to the feed stream, wherein the removing comprises transporting a first osmotic unit retentate inlet stream comprising at least a portion of the feed stream to a retentate side of an osmotic unit such that:
an osmotic unit retentate outlet stream exits the retentate side of the osmotic unit, the osmotic unit retentate outlet stream having a concentration of solubilized lithium cations that is greater than a concentration of solubilized lithium cations in the osmotic unit retentate inlet stream, such that at least a portion of the osmotic unit retentate outlet stream is part of the concentrated stream, and
at least a portion of liquid from the osmotic unit retentate inlet stream is transported from the retentate side of the osmotic unit, through an osmotic membrane of the osmotic unit, to a permeate side of the osmotic unit.
